(19) United States
(12) Patent Application Publication
(10) Pub. No.: US 2014/0053213 A1
(43) Pub. Date: Feb. 20, 2014

(54) VIDEO REPRODUCING APPARATUS, VIDEO TRANSMITTING APPARATUS, AND STORAGE MEDIUM

(71) Applicants: Toru Ueda, Osaka-shi (JP); Keiji Saka, Osaka-shi (JP); Yohichi Eguchi, Osaka-shi (JP); Ryosuke Ohmae, Osaka-shi (JP); Seiji Imanishi, Osaka-shi (JP); Takuya Kinoshita, Osaka-shi (JP)

(72) Inventors: Toru Ueda, Osaka-shi (JP); Keiji Saka, Osaka-shi (JP); Yohichi Eguchi, Osaka-shi (JP); Ryosuke Ohmae, Osaka-shi (JP); Seiji Imanishi, Osaka-shi (JP); Takuya Kinoshita, Osaka-shi (JP)

(73) Assignee: SHARP KABUSHIKI KAISHA, Osaka-shi, Osaka (JP)

(21) Appl. No.: 14/112,488

(22) PCT Filed: Apr. 4, 2012
(86) PCT No.: PCT/JP2012/059194

§ 371 Date: Oct. 17, 2013

(51) Int. Cl. H04N 21/482; H04N 21/266

(52) U.S. Cl. CPC H04N 21/482; H04N 21/266
USPC 725/60

(57) ABSTRACT

The monitor (10) of this invention includes: a wireless LAN module (12a); a content selecting section (11b) for selecting one of content sources; a video reception selecting section (11c) for (i) identifying a video transmitting apparatus connected to the selected one of the content sources and (ii) causing the wireless LAN module (12a) to receive a video signal from the identified video transmitting apparatus; and a content switching instructing section (11d) for instructing the identified video transmitting apparatus to transmit a video signal from the selected one of the content sources.

### TECHNICAL FIELD

The present invention relates to a content receiving system for receiving a video content.

### BACKGROUND ART

Recently, many portable display apparatuses (portable TVs) connectable to a network are on sale. There are various kinds of portable TVs with which a video or TV broadcasting can be watched.

As one form of the portable TV, the portable TV may include a display section (monitor section) and a video receiving section (tuner section) which are separately provided and are wirelessly connected to each other. With this form, the display section is portable, which improves convenience in personal use.

Further, since the portable TVs are strongly demanded to be connectable to the Internet, many portable TVs have a function of connecting to a network. Meanwhile, information apparatuses such as a personal computer are strongly demanded to allow a user to watch a TV program. In order to respond to this demand, wireless routers (access points; APs) having a tuner function are on sale. By connecting the information apparatus to such the AP, a user can watch, through wireless LAN, a video received via the AP. Further, it is generally conducted to connect the AP to wired LAN and also to an antenna line.

In many ordinary homes, a TV antenna cable and a LAN cable are located in different places. In such the case, either of the TV antenna cable and the LAN cable needs to be routed so as to be connected to a video receiving section. This is not favorable in terms of appearance.

A form considered in order to deal with this problem includes (i) an ordinary AP connected to wired LAN and (ii) an AP with a tuner connected only to an antenna. In this form, a user connects the information apparatus or the like to the ordinary AP in order to use the Internet, whereas the user connects the information apparatus or the like to the AP with the tuner in order to watch TV.

For example, as shown in FIG. 24, Patent Literature 1 discloses a TV receiving system 100 including: a wireless LAN access point 110, which is an AP via which Internet data is wirelessly transmitted; a baseband transmitter 120, which is an AP via which baseband data is wirelessly transmitted; and a receiver 140 for receiving a signal from any of these APs. The receiver 140 can handle wireless transmission of both of the Internet data and the baseband data by a single wireless LAN module. Thus, the receiver 140 has a simplified configuration, thereby making it possible to reduce cost.

For another example, as shown in FIG. 25, Patent Literature 2 discloses an electronic apparatus 201 including: a video relaying device 220 which is connected to a network and functions as an access point; and a display apparatus 210 which is detachably wire-connected to the video relaying device 220 and is wirelessly connectable to the video relaying device 220. While the display apparatus 210 is not connected to the video relaying device 220, the display apparatus 210 carries out wireless communication directly with a video server apparatus 230 and an information processing apparatus 240, each of which is a wireless terminal. Namely, the display apparatus 210 can switch from one connection destination for wireless communication to another (between the video relaying device 220, the video server apparatus 230, and the information processing apparatus 240).

### CITATION LIST

[Patent Literatures]

Patent Literature 1

Japanese Patent Application Publication, Tokukai, No. 2010-252205 A (Publication Date: Nov. 4, 2010)

Patent Literature 2

Japanese Patent Application Publication, Tokukai, No. 2007-181022 A (Publication Date: Jul. 12, 2007)

### SUMMARY OF INVENTION

Technical Problem

However, identifying the AP is typically managed by operation system (OS), and cannot be managed by an application of PC. This causes a problem of forcing a user to manually switch from one AP to another AP in order to, e.g., switch from a TV-watching mode to an Internet mode.

Specifically, according to Patent Literature 1, there exist two access points, the wireless LAN access point 110 and the baseband transmitter 120. However, Patent Literature 1 does not disclose switching from one access point to another access point according to selection of an application, a content, or a content source.

Further, according to Patent Literature 2, the display apparatus 210 merely switches one of a plurality of access points (wireless connection destinations) to another according to the connection form. Thus, according to Patent Literature 2, the access points are not switched from one to another according to selection of an application, a content, or a content source.

Furthermore, there may be cases where a certain content is accessible via a plurality of access points. However, through some communication routes, use of transmission resources is inefficient.

For this reason, a user needs to switch from one access point to another access point, and further to switch from one content source to another content source at the access point.

The present invention was made in order to solve the foregoing problems, and has an object to provide a video reproducing apparatus for receiving a video signal from any of a plurality of content sources via a corresponding one of a plurality of video transmitting apparatuses (access points), the video reproducing apparatus enabling a user to easily select one of the plurality of content sources.

Solution to Problem

A video reproducing apparatus according to the present invention includes: receiving means for wirelessly receiving a video signal from any of a plurality of video transmitting apparatuses, each of the plurality of video transmitting apparatuses being connected to at least one of content sources, each of which serves as a destination to which a video signal to be transmitted to the video reproducing apparatus is supplied; content selecting means for selecting one of the content sources in response to a user's operation; video reception selecting means for (i) identifying, from among the plurality of video transmitting apparatuses, a video transmitting apparatus connected to the selected one of the content sources and (ii) causing the receiving means to receive a video signal from the identified video transmitting apparatus; and instructing means for instructing the identified video transmitting apparatus to transmit a video signal supplied from the selected one of the content sources.

According to the above configuration, the video reception selecting means identifies the content source selected by the content selecting means, and causes the receiving means to receive the video signal from the identified video transmitting apparatus. Thus, switching from one video transmitting apparatus to another video transmitting apparatus is carried out automatically. Further, the instructing means instructs the identified video transmitting apparatus to transmit the video signal from the selected content source. This allows the receiving means to receive the video signal from the selected content source, thereby allowing the user to watch a desired content. Thus, it is possible to provide a video reproducing apparatus for receiving a video signal via any of a plurality of video transmitting apparatuses (access points), the video reproducing apparatus enabling the user to select a content source easily.

A video reproducing apparatus according to the present invention includes: receiving means for wirelessly receiving a video signal from any of a plurality of video transmitting apparatuses, each of the plurality of video transmitting apparatuses being connected to at least one of content sources, each of which serves as a destination to which a video signal to be transmitted to the video reproducing apparatus is supplied; selection screen display means for displaying a content selection screen indicating content sources which are reproducible; content selecting means for selecting one of the content sources in response to a user's operation carried out on the content selection screen; video reception selecting means for (i) identifying, from among the plurality of video transmitting apparatuses, a video transmitting apparatus connected to the selected one of the content sources and (ii) causing the receiving means to receive a video signal from the identified video transmitting apparatus; and instructing means for instructing the identified video transmitting apparatus to transmit a video signal from the selected one of the content sources, the selection screen display means being capable of changing the content sources which are reproducible, according to a type of the identified video transmitting apparatus.

Depending on the type of the video transmitting apparatus, a video signal from a certain content source cannot be reproduced. However, according to the above configuration, it is possible to inform a user of a content source which is not reproducible.

Advantageous Effects of Invention

As described above, the video reproducing apparatus according to the present invention is receiving means for wirelessly receiving a video signal from any of a plurality of video transmitting apparatuses, each of the plurality of video transmitting apparatuses being connected to at least one of content sources, each of which serves as a destination to which a video signal to be transmitted to the video reproducing apparatus is supplied; content selecting means for selecting one of the content sources in response to a user's operation; video reception selecting means for (i) identifying, from among the plurality of video transmitting apparatuses, a video transmitting apparatus connected to the selected one of the content sources and (ii) causing the receiving means to receive a video signal from the identified video transmitting apparatus; and instructing means for instructing the identified video transmitting apparatus to transmit a video signal supplied from the selected one of the content sources. Thus, the present invention provides a video reproducing apparatus for receiving a video signal via any of a plurality of video transmitting apparatuses (access points), the video reproducing apparatus enabling a user to easily select one of content sources.

### BRIEF DESCRIPTION OF DRAWINGS

FIG. 1 shows an overall configuration of a content receiving system according to an embodiment of the present invention.

FIG. 2 shows an example of a content selection screen displayed on a monitor shown in FIG. 1.

FIG. 3 shows a variation of the content selection screen.

FIG. 4 shows another variation of the content selection screen.

FIG. 5 shows further another variation of the content selection screen.

FIG. 6 is a table illustrating correspondence between content sources and DRMs of video signals.

FIG. 7 is a table illustrating correspondence between content sources and formats of video signals.

FIG. 8 is a block diagram illustrating a configuration of the monitor.

FIG. 9 is a block diagram illustrating a configuration of a DRM decoding section in the monitor shown in FIG. 8.

FIG. 10 shows an LUT to which a CPU in the monitor shown in FIG. 8 refers.

FIG. 11 is a block diagram illustrating a configuration of a video decoding section in the monitor shown in FIG. 8.

FIG. 12 is a flow chart illustrating how the monitor receives a video signal.

FIG. 13 is a block diagram illustrating a configuration of an STB shown in FIG. 1.

FIG. 14 is a block diagram illustrating a configuration of a DRM encryption section in the STB shown in FIG. 13.

FIG. 15 shows still further another variation of the content selection screen.

FIG. 16 shows yet another embodiment of the content selection screen.

FIG. 17 shows an overall configuration of a content receiving system according to a variation of the embodiment of the present invention.

FIG. 18 shows an overall configuration of a content receiving system according to another variation of the embodiment of the present invention.

FIG. 19 shows an overall configuration of a content receiving system according to further another variation of the embodiment of the present invention.

FIG. 20 shows an overall configuration of a content receiving system according to still further another variation of the embodiment of the present invention.

FIG. 21 is a flow chart of procedures for setting a transmission route from a content source to a smartphone.

FIG. 22 shows an example of a message shown in the smartphone.

FIG. 23 is a flow chart of a variation of procedures for setting a transmission route from a content source to a smartphone.

FIG. 24 shows a configuration of a conventional TV receiving system.

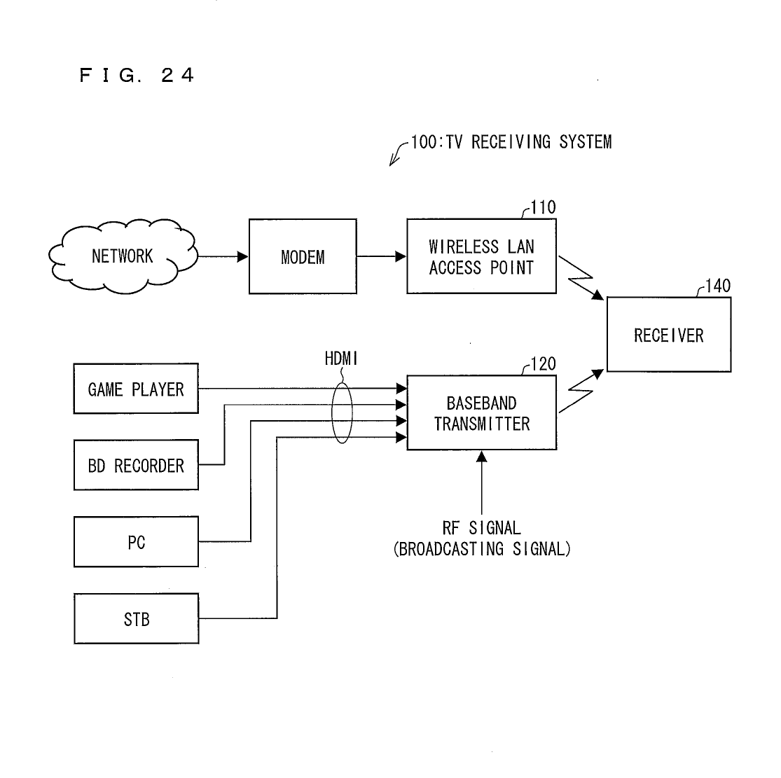

FIG. 25 shows a configuration of another conventional TV receiving system.

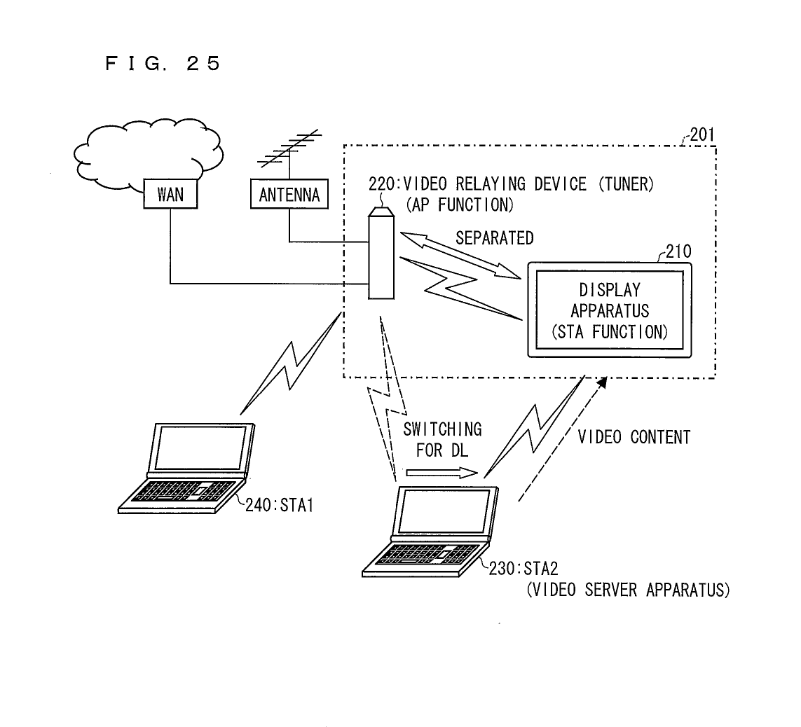

### DESCRIPTION OF EMBODIMENTS

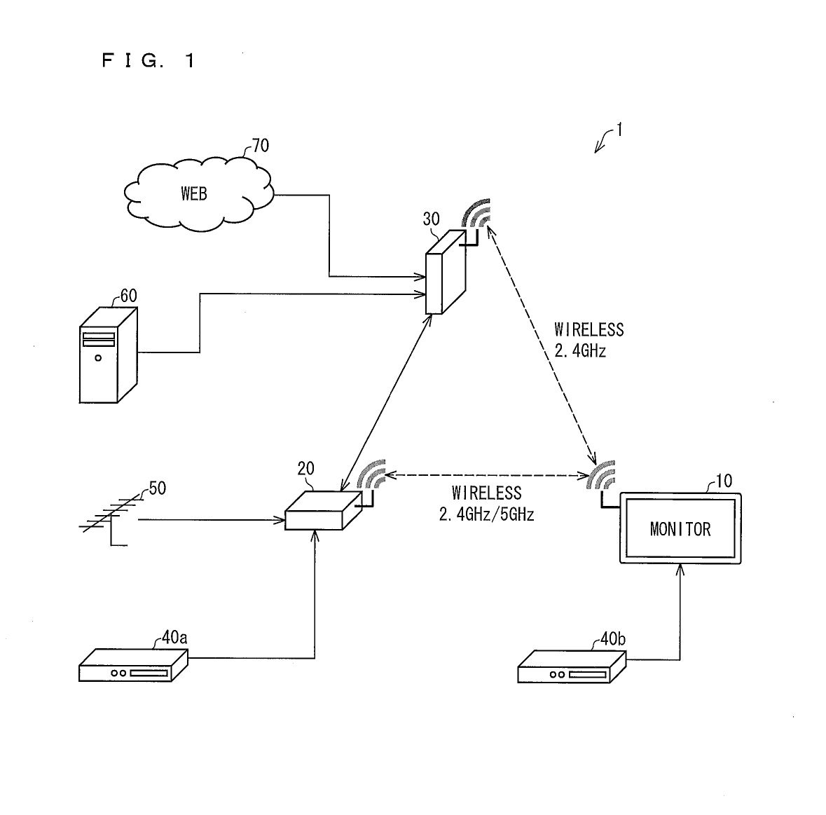

With reference to FIGS. 1 through 23, the following describes an embodiment of the present invention.

(Configuration of Content Receiving System)

FIG. 1 shows an overall configuration of a content receiving system 1 according to an embodiment of the present invention. The content receiving system 1 is a system for receiving a video content supplied from any of a plurality of content sources, and includes a monitor 10, a set-top box (STB) 20, and a router 30. The monitor 10 corresponds to a video reproducing apparatus recited in the claims, and each of the STB 20 and the router 30 corresponds to a video transmitting apparatus recited in the claims.

The STB 20 and the monitor 10 are configured according to the following setting: An identification code (e.g., an MAC address) by which its corresponding apparatus is identified is used, and wireless connection is allowed only between apparatuses having their certain identification codes. The reason why such the setting is employed is as follows: The present embodiment assumes one product made of a combination of the STB 20 and the monitor 10, that is, the combination of the STB 20 and the monitor 10 is fixed as one product, thereby omitting an operation required in an initial setting for wireless connection between the STB 20 and the monitor 10 in order to eliminate an unnecessary burden on a user.

Each of the STB 20 and the router 30 functions as an access point at which a content source is relayed. The “access point” means a terminal having a radio wave relay function for wirelessly connecting one terminal to another terminal or to a server.

The monitor 10 is the video reproducing apparatus for wirelessly receiving a video signal from the STB 20 or the router 30. The monitor 10 can selectively switch from the STB 20 to the router 30, or vice versa, so as to select a connection destination. A wireless frequency band in which the monitor 10 and the STB 20 are connected to each other can be set to 2.4 GHz or 5 GHz. A wireless frequency band in which the monitor 10 and the router 30 are connected to each other is 2.4 GHz. The STB 20 and the router 30 may be wire-connected. A wireless frequency band in which the monitor 10 and the router 30 are connected to each other may be 5 GHz, or may be set to 2.4 GHz or 5 GHz by switching them.

In the present embodiment, the plurality of content sources include, for example, BD recorders 40a and 40b (each of which is an HDMI device), a DTV/BS antenna 50, a media server 60 (which is a DLNA device), and a web 70.

The BD recorder 40a and the DTV/BS antenna 50 are connected to the STB 20, whereas the media server 60 and the web 70 are connected to the router 30. Thus, the monitor 10 can receive a video content from the BD recorder 40a or the DTV/BS antenna 50 via the STB 20, and can receive a video content from the media server 60 or the web 70 via the router 30. Further, the HDMI devices such as the BD recorder 40b are connectable to the monitor 10.

Note here that the monitor 10 is configured as follows: Without forcing a user to switch from a first access point to a second access point (the first and second access points are respectively the STB 20 and the router 30, or vice versa), the monitor 10 enables a user to easily select, through a content selection screen, a content source which is to be accessed via the second access point.

(Content Selection Screen)

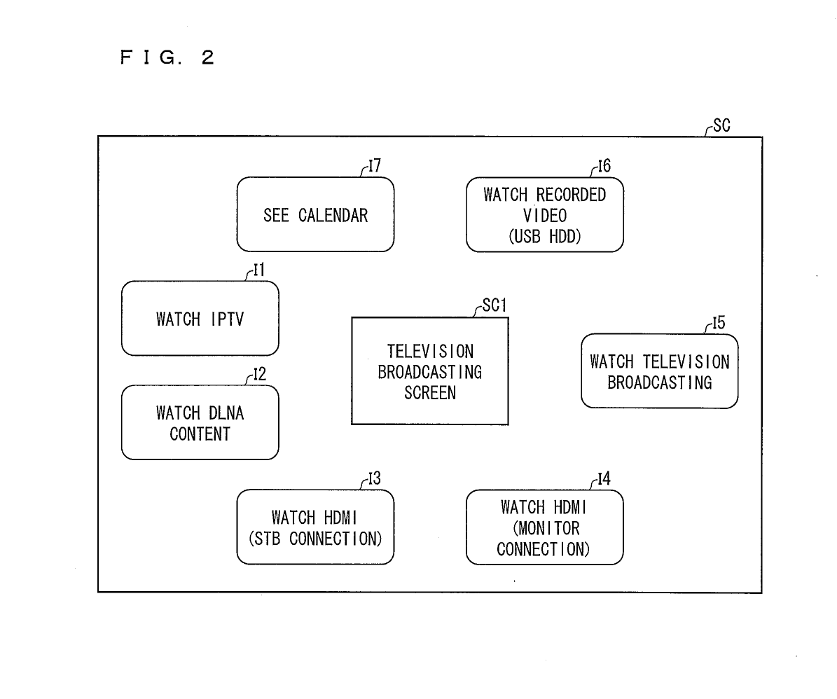

FIG. 2 shows an example of a content selection screen SC displayed on the monitor 10. In the content selection screen SC, a television broadcasting screen SC1 is displayed on a center part, and seven icons I1 through I7, each indicating a watchable content, are displayed so as to surround the television broadcasting screen SC1.

For example, the icon I1 is an icon for watching IPTV broadcasting supplied from the web 70 shown in FIG. 1. The icon I2 is an icon for watching a content supplied from the media server 60 (DLNA device). The icon I3 is an icon for watching a content supplied from the BD recorder 40a, which is the HDMI device connected to the STB 20. The icon I4 is an icon for watching a content supplied from the BD recorder 40b, which is the HDMI device connected to the monitor 10. The icon I5 is an icon for watching TV broadcasting supplied via the DTV/BS antenna 50. The icon I6 is an icon for watching a content supplied from a hard disc device (not shown in FIG. 1) connectable to the monitor 10 via a USB terminal. The icon I7 is an icon for displaying a calendar with use of a calendar display function of the monitor 10.

Each of the icons may be the one in which an image such as a related still image or moving image is displayed in a small size. By displaying such an image, it is clearly indicated that the icon is of a video content. Further, by setting an image of the icon so as to correspond to the content, it is possible to improve user's convenience.

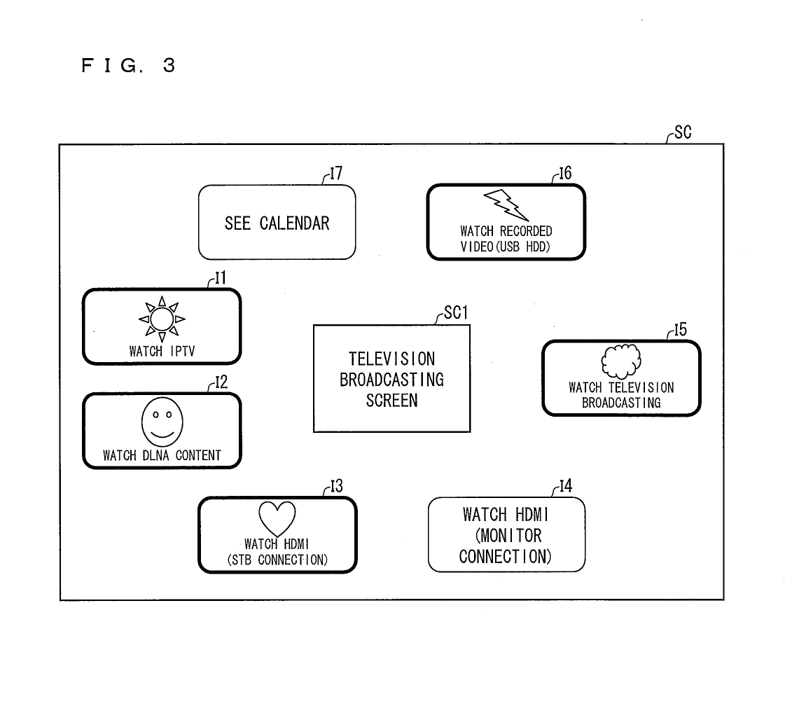

As shown in FIG. 3, for example, the icon I1 for IPTV may include a small image of a latest available content. The icon I2 for DLNA may include an image of a content randomly selected from reproducible contents, or an image of a content of a DVD or a BD in a case where the DVD or the BD is reproducible. The same applies to the icon I3 for the HDMI device and the icon I6 for USB-HDD. The icon I5 for TV broadcasting may include an image of a currently broadcasted program. The program displayed in the icon I5 may be (i) a program supplied by a broadcasting station that most recently a user watched or (ii) a program supplied by a randomly selected broadcasting station.

The images are obtained, for example, by the following manner. Parts of the contents are sequentially obtained from the connection apparatuses, are stored in a memory in the monitor, and then are displayed.

In FIG. 2, the icon I2 displays “WATCH DLNA CONTENT”, for example. Instead of such the icon I2, plural kinds of thumbnails indicating DLNA contents may be displayed so that the user makes selection from these thumbnails.

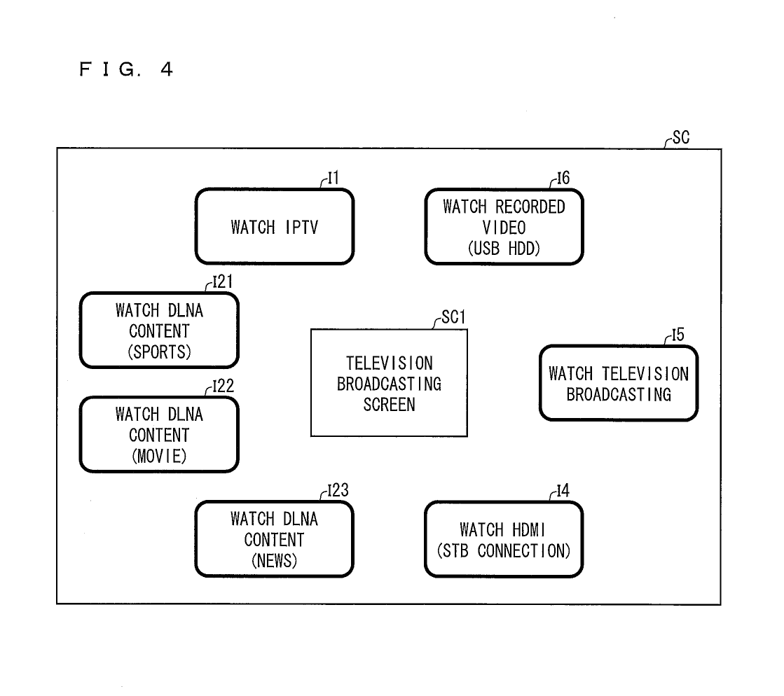

As shown in FIG. 4, for example, a plurality of thumbnails for certain genres of DLNA contents may be displayed. In a case where DLNA contents include a baseball game, a football game, a foreign film, and a news program, three thumbnails for genres of sports, movie, and news (icons I21, I22, and I23) may be displayed. This arrangement saves efforts required to search for a desired one among the DLNA contents, and also allows the user to roughly understand the kinds of DLNA contents merely by looking the thumbnails.

Alternatively, all of the DLNA contents may be displayed in thumbnails. This arrangement is suitable because the user can understand all the DLNA contents. Further alternatively, only a predetermined number of DLNA contents may be displayed. Further, contents to be displayed in thumbnails may be changed at regular intervals.

By operating a remote controller for example, the user can select, from the icons I1 through I7, an icon indicating a content that the user wants to watch. As a result, a screen corresponding to the selected icon is displayed. The contents are obtained from various content sources shown in FIG. 1, and are different from each other in DRM (digital rights management) and a format of a video signal. Upon selection of one of the content sources in the above-described manner, a format and DRM of a video signal are changed at the same time.

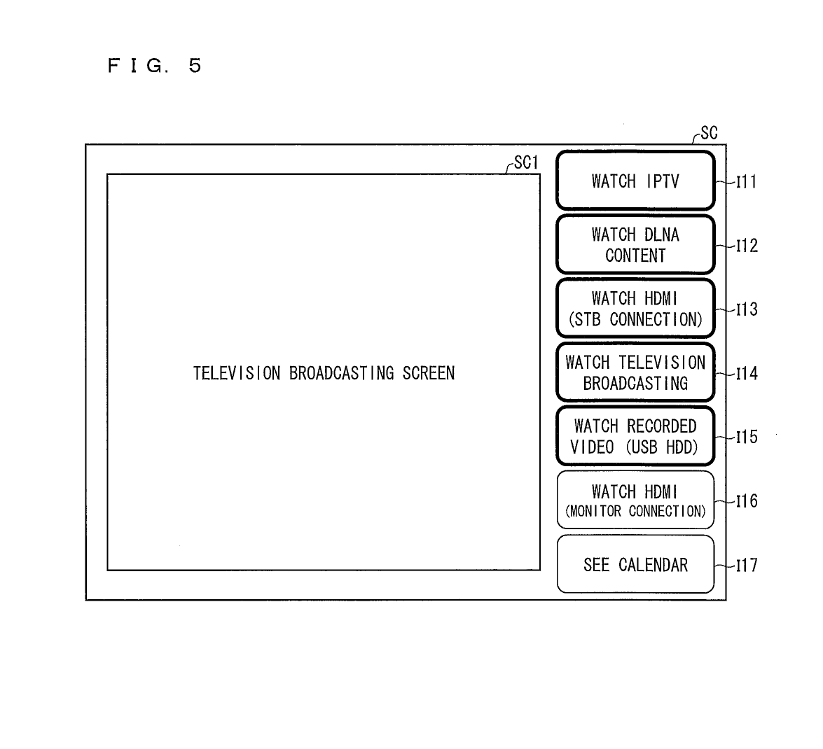

Note that the screen for content selection only needs to be the one by which the user can select a content source easily, and is not limited to the above-described one in which the icons are displayed in a circle. As shown in FIG. 5, icons I11 through I17 may be displayed in a line on the right side of the television broadcasting screen SC1. Alternatively, icons may be displayed in vertical or lateral lines between which the television broadcasting screen is sandwiched.

(Format and DRM of Video Signal)

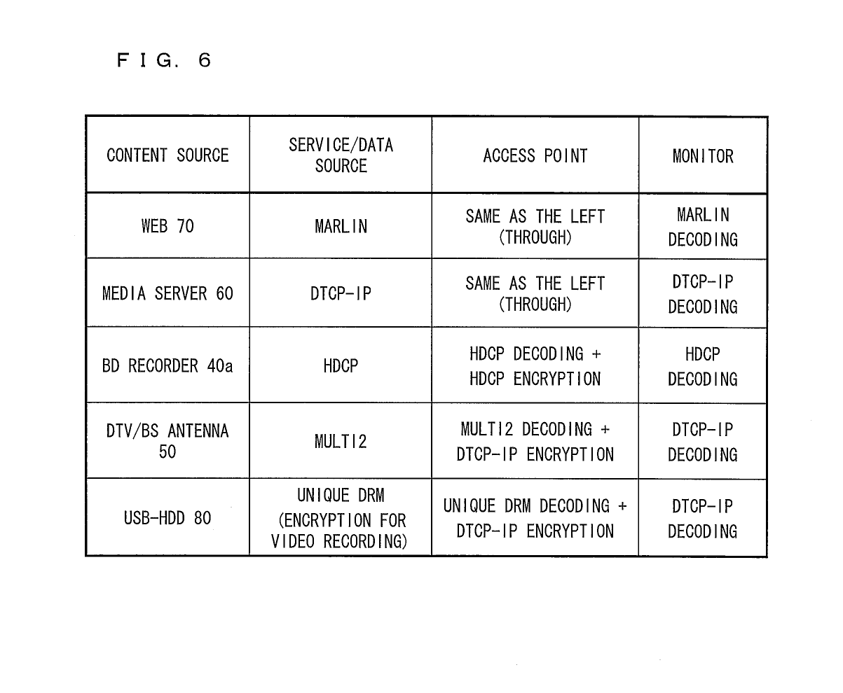

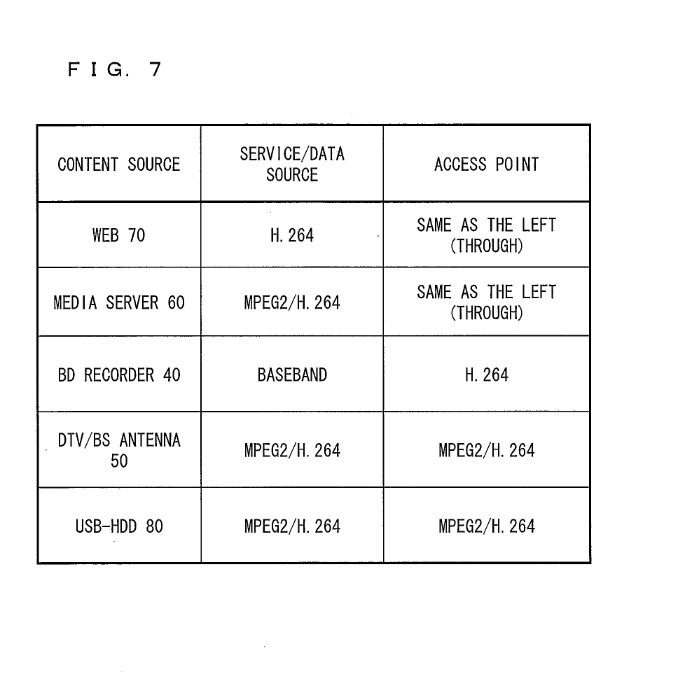

FIG. 6 is a table illustrating correspondence between content sources and DRMs of video signals. FIG. 7 is a table illustrating correspondence between content sources and formats of video signals.

In FIG. 6, for example, a video signal from the BD recorder 40a is encrypted by use of certain key information according to the HDCP format. The encrypted video signal is decoded at the access point (STB 20) according to the HDCP format, and then is encrypted by use of another key information according to the HDCP format. Then, the encrypted video signal is transmitted to the monitor 10. The reason why the video signal is encrypted after the decoding is that (i) encryption carried out, on HDMI, with respect to the video signal supplied from the BD recorder 40a and (ii) encryption of the video signal supplied from the access point to the monitor 10 need to be independent from each other. Meanwhile, an on-demand video from the web 70 (a server on the Internet) or a video signal from IPTV (multicast broadcasting) is encrypted according to the Marlin format, and is transmitted to the monitor 10 without having its format changed at the access point (router 30). Meanwhile, a video signal from the media server 60, which is a device for a DLNA home network, is encrypted with use of a digital rights management technique according to DTCP-IP at the media server 60.

Similarly, in FIG. 7, a video signal from the DTV/BS antenna 50, for example, is compressed according to the MPEG2 or H.264 format. The video signal thus compressed is transmitted from the access point (STB 20) to the monitor 10 while keeping its compressed state according to the MPEG2 or H.264 format.

(Configuration of Monitor)

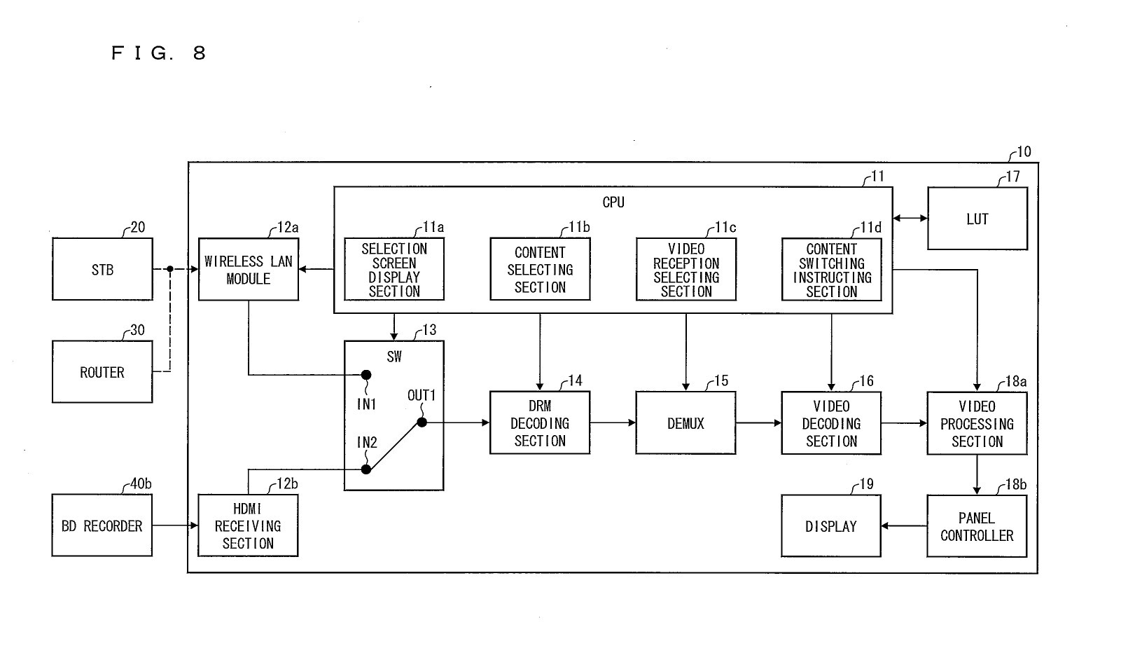

FIG. 8 is a block diagram illustrating a configuration of the monitor 10. The monitor 10 decodes a video signal received from the STB 20 or the router 30 over Wi-Fi, and displays a video corresponding to the video signal. The monitor 10 has a similar basic system to those of the STB 20 and ordinary televisions. Specifically, the monitor 10 includes a CPU 11, a wireless LAN module (receiving means) 12a, an HDMI receiving section 12b, a switch (SW) 13, a DRM decoding section 14, a DEMUX 15, a video decoding section 16, a look-up table (LUT) 17, a video processing section 18a, a panel controller 18b, and a display 19. The monitor 10 also includes a display lamp such as an LED (not shown). The panel controller 18b and the display 19 may be externally attached to the monitor 10.

The CPU 11 includes a selection screen display section (selection screen display means) 11a, a content selecting section (content selecting means) 11b, a video reception selecting section (video reception selecting means) 11c, and a content switching instructing section (instructing means) 11d. The CPU 11 controls the wireless LAN module 12a, the SW 13, the DRM decoding section 14, the DEMUX 15, the video decoding section 16, and the video processing section 18a.

The wireless LAN module 12a is wirelessly connected to the STB 20 and the router 30, and receives a video signal from the STB 20 or the router 30. The HDMI receiving section 12b is connected to the BD recorder 40b.

The SW 13 includes two input terminals IN1 and IN2 and one output terminal OUT1. The input terminal IN1 is connected to the wireless LAN module 12a, and the input terminal IN2 is connected to the HDMI receiving section 12b. According to an instruction from the CPU 11, the SW 13 selects either of the input terminals IN1 and IN2, and outputs a signal from the output terminal OUT1.

The selection screen display section 11a causes the display 19 to display the content selection screen shown in FIG. 2 in response to a user's operation. The content selecting section 11b selects one of the content sources in response to a user's operation carried out on the content selection screen.

The video reception selecting section 11c controls the wireless LAN module 12a and the SW 13. Specifically, the video reception selecting section 11c judges whether the one of the content sources selected by the content selecting section 11b is the one supplying a content via the access point (the STB 20 or the router 30) or the one supplying a content via HDMI, according to the LUT 17 including preset correspondence between the content sources and the apparatuses via which contents are supplied. If the selected one of the content sources is determined to be the one supplying a content via the access point, the video reception selecting section 11c identifies the access point connected to the selected one of the content sources. Further, the video reception selecting section 11c causes the wireless LAN module 12a to receive a video signal from the identified access point, and causes the SW 13 to select the input terminal IN1, which is connected to the wireless LAN module 12a.

For example, in a case where the selected one of the content sources is the BD recorder 40a shown in FIG. 1, the video reception selecting section 11c identifies that the STB 20 is an access point connected to the BD recorder 40a, and causes the wireless LAN module 12a to receive a video signal from the STB 20.

In a case where the selected one of the content sources is the one supplying a content via HDMI, the video reception selecting section 11c causes the SW 13 to select the input terminal IN2, which is connected to the HDMI receiving section 12b.

The content switching instructing section 11d instructs the access point identified by the video reception selecting section 11c to transmit the video signal from the selected one of the content sources. For example, in the case where the selected one of the content sources is the BD recorder 40a as described above, the content switching instructing section 11d transmits a preset control command to the STB 20, so as to instruct the STB 20 to transmit the video signal from the BD recorder 40a. As a result, the wireless LAN module 12a receives, via the STB 20, the video signal from the BD recorder 40a.

As described above, a video signal from a content source selected by the user is received by the wireless LAN module 12a or the HDMI receiving section 12b, and then is outputted from the SW 13.

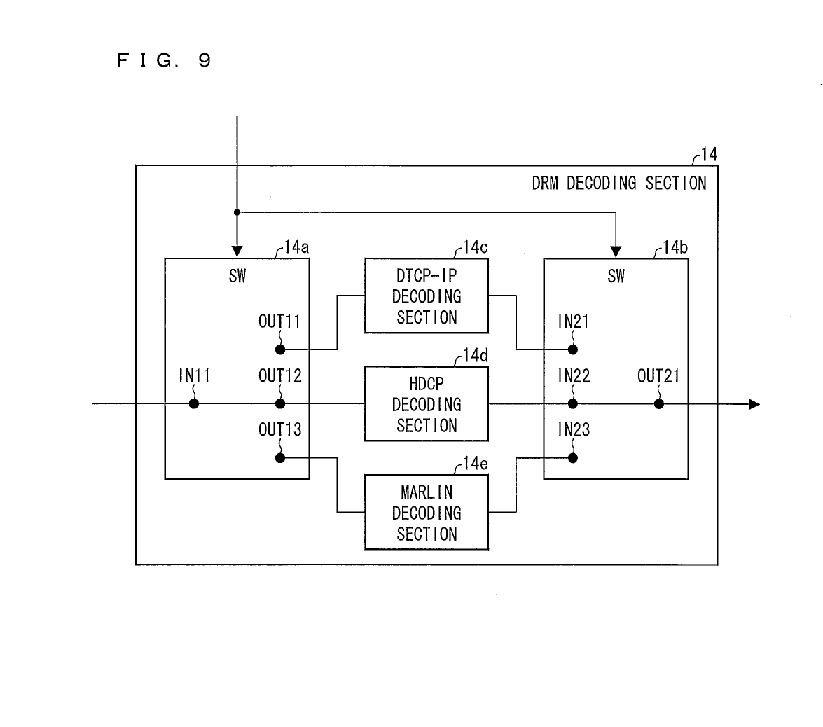

The DRM decoding section 14 decodes DRM data according to the DRM encryption format of the video signal outputted from the SW 13. As shown in FIG. 9, the DRM decoding section 14 includes two SWs 14a and 14b, a DTCP-IP decoding section 14c, an HDCP decoding section 14d, and a Marlin decoding section 14e.

The SW 14a includes one input terminal IN11 and three output terminals OUT11 through OUT13. The SW 14b includes three input terminals IN21 through IN23 and one output terminal OUT21. Switching from the SW 14a to the SW 14b, or vice versa, is controlled by the CPU 11.

The DTCP-IP decoding section 14c decodes a video signal encrypted according to the DTCP-IP format. The DTCP-IP decoding section 14c is provided between the output terminal OUT11 of the SW 14a and the input terminal IN21 of the SW 14b. The HDCP decoding section 14d decodes a video signal encrypted according to the HDCP format. The HDCP decoding section 14d is provided between the output terminal OUT 12 of the SW 14a and the input terminal IN22 of the SW 14b. The Marlin decoding section 14e decodes a video signal encrypted according to the Marlin format. The Marlin decoding section 14e is provided between the output terminal OUT13 of the SW 14a and the input terminal IN23 of the SW 14b.

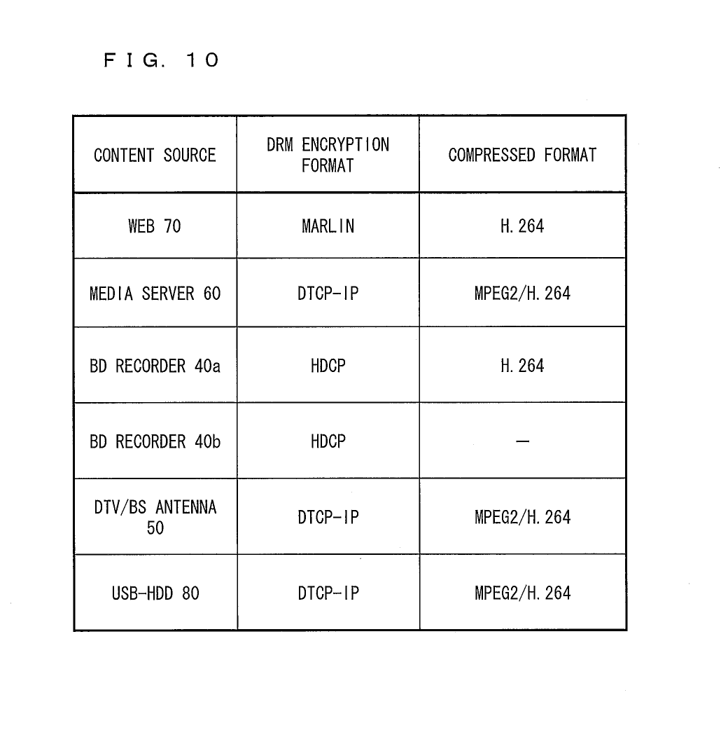

The CPU 11 refers to the LUT 17 stored in a memory (not shown) so as to control switching from the SW 14a to the SW 14b, or vice versa. FIG. 10 shows an example of a content of the LUT 17. As shown in FIG. 10, the LUT 17 shows correspondence between (i) the content sources and (ii) DRM encryption formats and compressed formats of video signals.

Thus, the CPU 11 controls the DRM decoding section 14 so as to select a decoding section for a DRM encryption format of a video signal from a selected content source. In a case where the video signal received by the CPU 11 is a video signal from the web 70, the CPU 11 controls the DRM decoding section 14 so that the Marlin decoding section 14e is selected. Namely, the CPU 11 controls the SW 14a so as to select the output terminal OUT14, and controls the SW 14b so as to select the input terminal IN24. Similarly, in a case where the video signal received by the CPU 11 is a video signal from the DTV/BS antenna 50, the media server 60, or a USB-HDD 80 (described later), the CPU 11 controls the DRM decoding section 14 so that the DTCP-IP decoding section 14c is selected. Further, in a case where the video signal received by the CPU 11 is a video signal from the BD recorder 40a or the BD recorder 40b, the CPU 11 controls the DRM decoding section 14 so that the HDCP decoding section 14d is selected.

The DEMUX 15 demultiplexes, from the video signal outputted by the DRM decoding section 14, mainly an IPTV video signal supplied from the web 70, for example. The video signal outputted from the DEMUX 15 is inputted to the video decoding section 16.

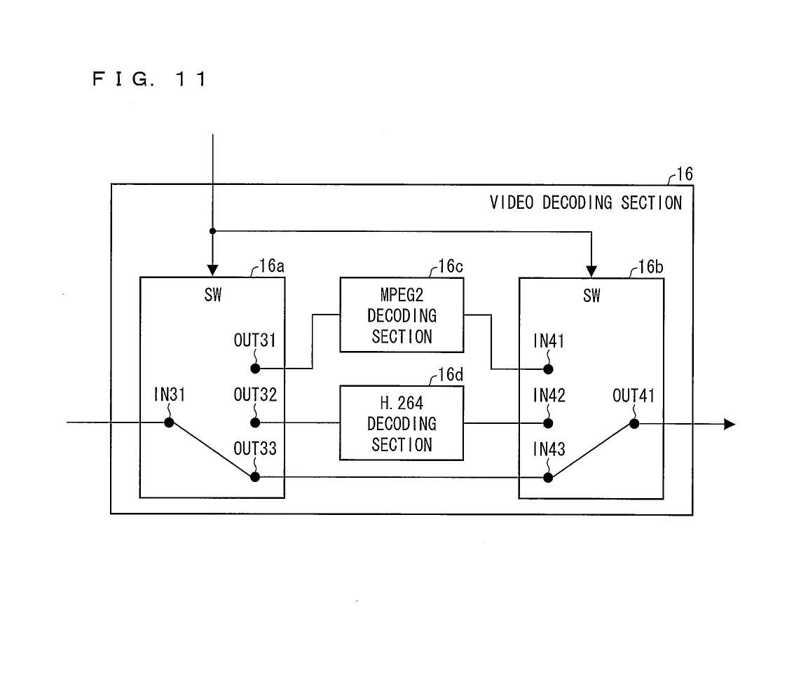

The video decoding section 16 decodes the video signal according to a compressed format of the video signal. As shown in FIG. 11, the video decoding section 16 includes two SWs 16a and 16b, an MPEG2 decoding section 16c, and an H.264 decoding section 16d.

The SW 16a includes one input terminal IN31 and three output terminals OUT31 through OUT33. The SW 16b includes three input terminals IN41 through IN43 and one output terminal OUT41. Switching from the SW 16a to the SW 16b, or vice versa, is controlled by the CPU 11.

The MPEG2 decoding section 16c decodes a video signal compressed according to the MPEG2 format. The MPEG2 decoding section 16c is provided between the output terminal OUT31 of the SW 16a and the input terminal IN41 of the SW 16b. The H.264 decoding section 16d decodes a video signal compressed according to the H.264 format. The H.264 decoding section 16d is provided between the output terminal OUT32 of the SW 16a and the input terminal IN42 of the SW 16b. The output terminal OUT33 of the SW 16a and the input terminal IN43 of the SW 16b are directly connected to each other.

The CPU 11 refers to the LUT 17 so as to control switching from a SW 16a to a SW 16b, or vice versa. Specifically, the CPU 11 refers to the correspondence between the content sources and the compressed formats indicated in the LUT 17 shown in FIG. 10 so as to carry out control to select a decoding section for a compressed format of a video signal from a selected content source. For example, in a case where the video signal received by the CPU 11 is a video signal from the BD recorder 40a or the web 70, the CPU 11 controls the video decoding section 16 so that the H.264 decoding section 16d is selected. Namely, the CPU 11 controls the SW 16a so as to select the output terminal OUT32, and controls the SW 16b so as to select the input terminal IN42. Similarly, in a case where the video signal received by the CPU 11 is a video signal from the DTV/BS antenna 50, the media server 60, or the USB-HDD 80, the CPU 11 controls the video decoding section 16 so that the MPEG2 decoding section 16c or the H.264 decoding section 16d is selected according to the format in which the video signal is compressed. Note that, since a video signal from the BD recorder 40b is a baseband signal, the CPU 11 controls the SW 16a so as to select the output terminal OUT33, and controls the SW 16b so as to select the input terminal IN43.

The video signal outputted from the video decoding section 16 is inputted to the video processing section 18a. The video processing section 18a subjects the video signal to a process such as a predetermined image quality correction, and outputs the video signal to the display 19 via the panel controller 18b. As a result, a video content from the selected content source is displayed on the display 19.

As described above, only by a user's operation of selecting a content on the content selection screen SC shown in FIG. 2, (i) switching from one of the access points to another and (ii) selection of a content source at the access point are automatically executed.

Note that the types of the plurality of decoding sections included in the DRM decoding section 14 are changed as appropriate depending on the types of encryption formats of video signals received by the monitor 10.

(Procedures for Receiving Video Signal)

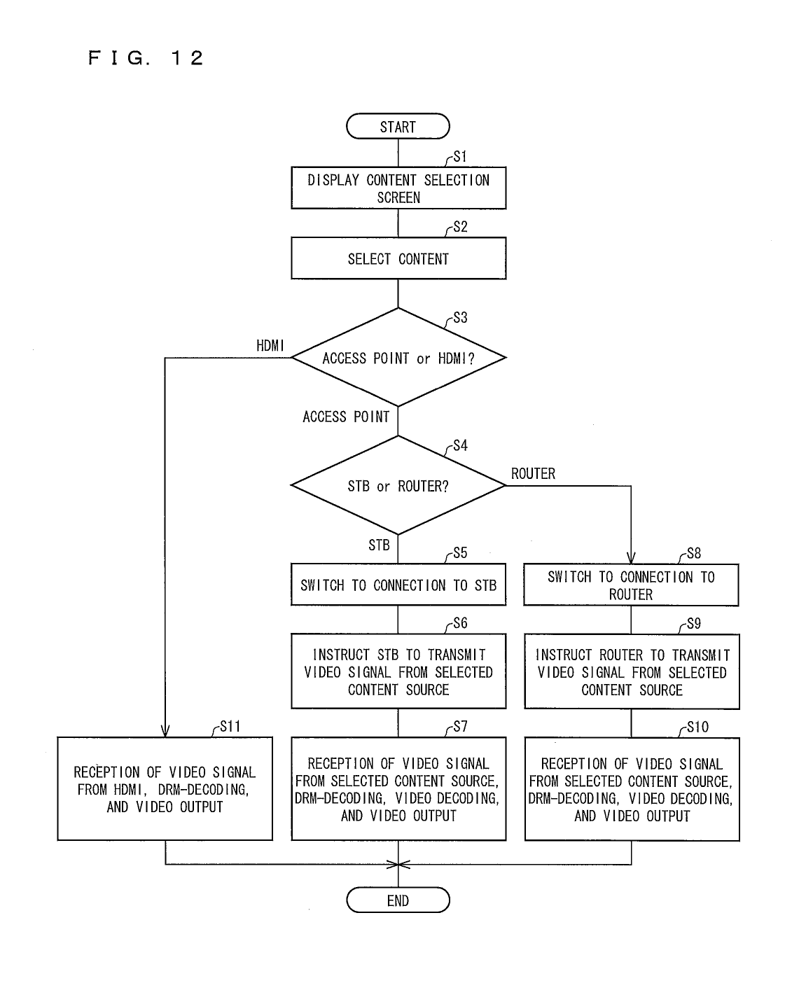

FIG. 12 is a flow chart illustrating how the monitor 10 receives a video signal.

The content selection screen is displayed (51), and a content is selected by a user's operation (S2). In response to the selection, the video reception selecting section 11c judges whether the selected content source is the one supplying a content via the access point or the one supplying a content via HDMI.

In a case where the selected content source is the one supplying a content via the access point, the video reception selecting section 11c identifies whether the access point connected to the selected content source is the STB 20 or the router 30 (S4).

In a case where the identified access point is the STB 20, the video reception selecting section 11d causes the wireless LAN module 11a to receive a video signal from the STB 20, and causes the SW 13 to select the input terminal IN1, which is connected to the wireless LAN module 12a (S5). Further, the content switching instructing section 11d instructs the STB 20 to transmit a video signal from the selected content source (S6). As a result, reception of the video signal from the selected content source via the STB 20, DRM-decoding of the video signal, and video decoding and video outputting are carried out (S7). Specifically, the wireless LAN module 12a receives the video signal from the STB 20. Further, according to the DRM encryption format of the received video signal, one of the three decoding sections 14c through 14e in the DRM decoding section 14 is selected so that the video signal is DRM-decoded. Furthermore, after the video signal thus DRM-decoded is demultiplexed as appropriate, either one of the two decoding sections 16c and 16d in the video decoding section 16 is selected so that the video signal is decoded according to the compressed format of the video signal. Then, the video signal thus decoded is transmitted to the video processing section 18a and then to the panel controller 18b. Consequently, the video is supplied to the display 19.

Meanwhile, in a case where the access point identified in S4 is the router 30, the video reception selecting section 11c causes the wireless LAN module 12a to receive a video signal from the router 30, and causes the SW 13 to select the input terminal IN1, which is connected to the wireless LAN module 12a (S8). Further, the content switching instructing section 11d instructs the router 30 to transmit a video signal from the selected content source (S9). As a result, reception of the video signal from the selected content source via the router 30, DRM-decoding of the video signal, and video decoding and video outputting are carried out (S10). Specifically, the wireless LAN module 12a receives the video signal from the router 30. Further, according to the DRM encryption format of the received video signal, one of the three decoding sections 14c through 14e in the DRM decoding section 14 is selected so that the video signal is DRM-decoded. Furthermore, after the video signal thus DRM-decoded is demultiplexed as appropriate, either one of the two decoding sections 16c and 16d in the video decoding section 16 is selected so that the video signal is decoded according to the compressed format of the video signal. Then, the video signal thus decoded is transmitted to the video processing section 18a and then to the panel controller 18b. Consequently, the video is supplied to the display 19.

Meanwhile, in a case where the selected content source is determined to be the one supplying a content via HDMI in S3, the video signal is received via HDMI, the video signal is DRM-decoded, and a video is outputted (S11). Specifically, the video reception selecting section 11c causes the HDMI receiving section 12b to receive the video signal from the selected content source (BD recorder 40b), and causes the SW 13 to select the input terminal IN2, which is connected to the HDMI receiving section 12b. Further, according to the DRM encryption format of the received video signal, one (in the present embodiment, the HDCP decoding section 14d) of the three decoding sections 14c through 14e in the DRM decoding section 14 is selected so that the video signal is DRM-decoded. Furthermore, the video signal thus DRM-decoded is transmitted to the video processing section 18a and then to the panel controller 18b. Consequently, a video is supplied to the display 19.

As described above, merely by carrying out an operation of selecting a content, the user of the monitor 10 can display the selected content. Namely, as well as in an operation carried out on an ordinary television to which a plurality of content sources are directly connected, the user of the monitor 10 can switch from one of the access points to another and switch from one of the content sources to another while feeling as if the user directly selected a content source.

Note that the STB 20 and the router 30 have their specific characteristics. The STB 20 has a function to allow the user to watch broadcasting. Therefore, the monitor 10 directly connected to the STB 20 can directly use functions specific to the STB 20, for example, the broadcasting watching function. Meanwhile, the router 30 has a function to allow the user to access the external Internet. Therefore, via the router 30, it is possible to access the Internet without use of a band of other route. For example, although it is possible to access the router 30 via the STB 20, this unnecessarily uses a transmission resource between the STB 20 and the router 30, whereas such the unnecessary use does not occur in a case where the monitor 10 is directly connected to the router 30.

(Configuration of STB)

Next, the following describes a configuration of the STB 20. As shown in FIG. 1, the STB 20 is connected to the BD recorder 40a and the DTV/BS antenna 50, each of which serves as a content source. Further, as shown in FIG. 6, the STB 20 encrypts video signals from the content sources for copyright protection. Specifically, the STB 20 decodes a video signal from the BD recorder 40a according to HDCP, and then encrypts the video signal by use of another key information according to HDCP. The STB 20 encrypts a video signal from the DTV/BS antenna 50 according to DTCP-IP. The STB 20 decodes a video signal from the USB-HDD 80 according to a unique DRM, and encrypts the video signal according to DTCP-IP.

Thus, the STB 20 can change an encryption format according to the content source. An arrangement therefor is described below.

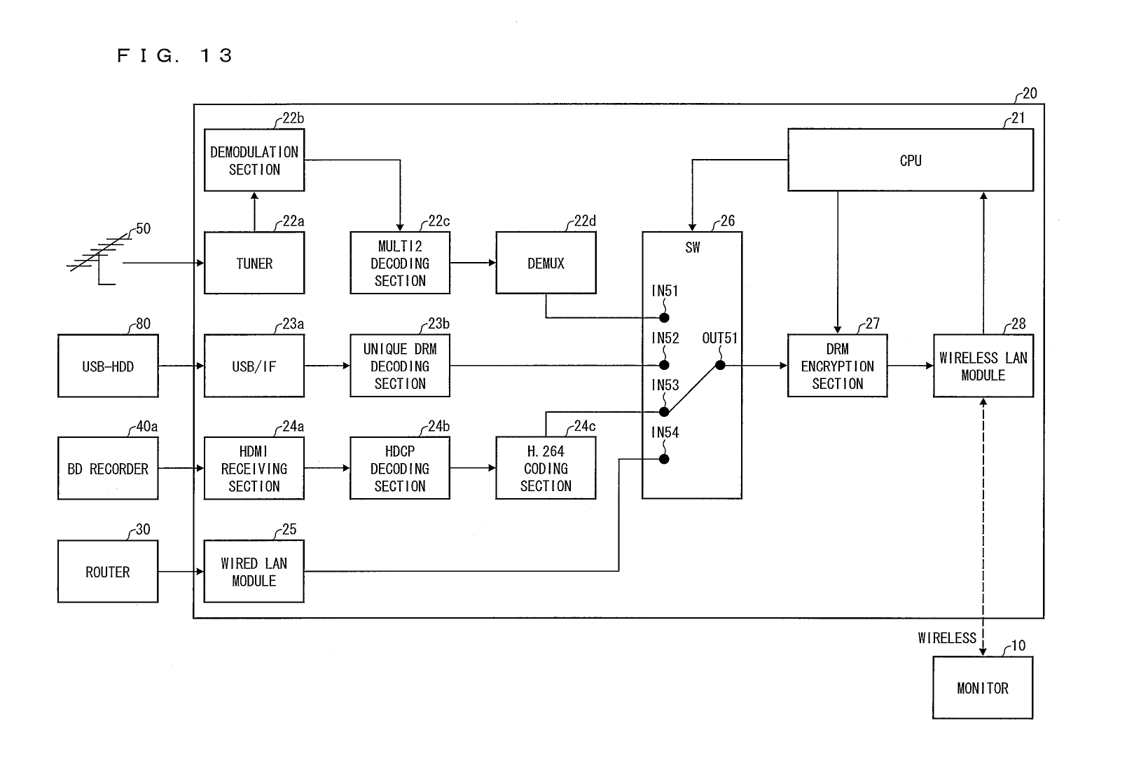

FIG. 13 is a block diagram illustrating a configuration of the STB 20. The STB 20 includes, in a section corresponding to a panel output section of a general television, a wireless transmission system which outputs a video signal to the monitor 10 via Wi-Fi. Specifically, the STB 20 includes a CPU (video input control means) 21, a tuner (video input means) 22a, a demodulation section 22b, a Multi2 decoding section 22c, a DEMUX 22d, a USB interface (USB/IF, video input means) 23a, a unique DRM decoding section 23b, an HDMI receiving section (video input means) 24a, an HDCP decoding section 24b, an H.264 coding section 24c, a wired LAN module (video input means) 25, a switch (SW, video input control means) 26, a DRM encryption section (content protection means) 27, and a wireless LAN module 28.

Each of the tuner 22a, the USB/IF 23a, the HDMI receiving section 24a, and the wired LAN module 25 corresponds to video input means recited in the claims. The tuner 22a, the USB/IF 23a, the HDMI receiving section 24a, and the wired LAN module 25 are connected to the DTV/BS antenna 50, the USB-HDD 80, the BD recorder 40a, and the router 30, respectively. The wireless LAN module 28 is wirelessly connected to the monitor 10.

A video signal received by the tuner 22a is demodulated by the demodulation section 22b, and is then DRM-decoded by the Multi2 decoding section 22c. After that, the video signal is demultiplexed by the DEMUX 22d, and is then inputted to the SW 26.

A video signal received by the USB/IF 23a is DRM-decoded by the unique DRM decoding section 23b, and is inputted to the SW 26.

A video signal received by the HDMI receiving section 24a is DRM-decoded by the HDCP decoding section 24b, is compressed by the H.264 coding section 24c, and is then inputted to the SW 26. Note that the video signal decoded by the HDCP decoding section 24b may be inputted to the SW 26 without being compressed. However, it is desirable that the video signal be compressed by, e.g., H.264, since a transmission speed is limited in a wireless communication section.

The SW 26 includes four input terminals IN51 through

IN54 and one output terminal OUT51. The input terminal IN51 is connected to the DEMUX 22d, the input terminal IN52 is connected to the unique DRM decoding section 23b, the input terminal IN53 is connected to the H.264 coding section 24c, and the input terminal IN54 is connected to the wired LAN module 25. The SW 26 selects one of the input terminals IN51 through IN54 according to an instruction from the CPU 21, and outputs a video signal from the output terminal OUT51.

As described above, upon selection of a content source in the monitor 10 shown in FIG. 8 by a user's operation, the access point connected to the selected content source is identified. Further, the wireless LAN module 12a receives a video signal from the identified access point, and the content switching instructing section 11d instructs the identified access point to transmit a video signal from the selected content source. Thus, in a case where the selected content source is a content source connected to the STB 20, the content switching instructing section 11d in the monitor 10 instructs the STB 20 to transmit the video signal from the selected content source.

An instruction signal from the content switching instructing section 11d is inputted to the CPU 21. According to the instruction from the content switching instructing section 11d, the CPU 21 controls the SW 26 and the DRM encryption section 27. Thus, the STB 20 encrypts the video signal from the selected content source according to a DRM encryption format of the video signal, and transmits the video signal to the monitor 10.

For example, in a case where the selected content source is the BD recorder 40a, the CPU 21 controls the SW 26 to select the input terminal IN53. Consequently, only a video signal received by the HDMI receiving section 24a is selected and outputted to the DRM encryption section 27. Similarly, in a case where the selected content source is the DTV/BS antenna 50, the CPU 21 controls the SW 26 to select the input terminal IN51. In a case where the selected content source is the

USB-HDD 80, the CPU 21 controls the SW 26 to select the input terminal IN52. In a case where the selected content source is the router 30, the CPU 21 controls the SW 26 to select the input terminal IN54.

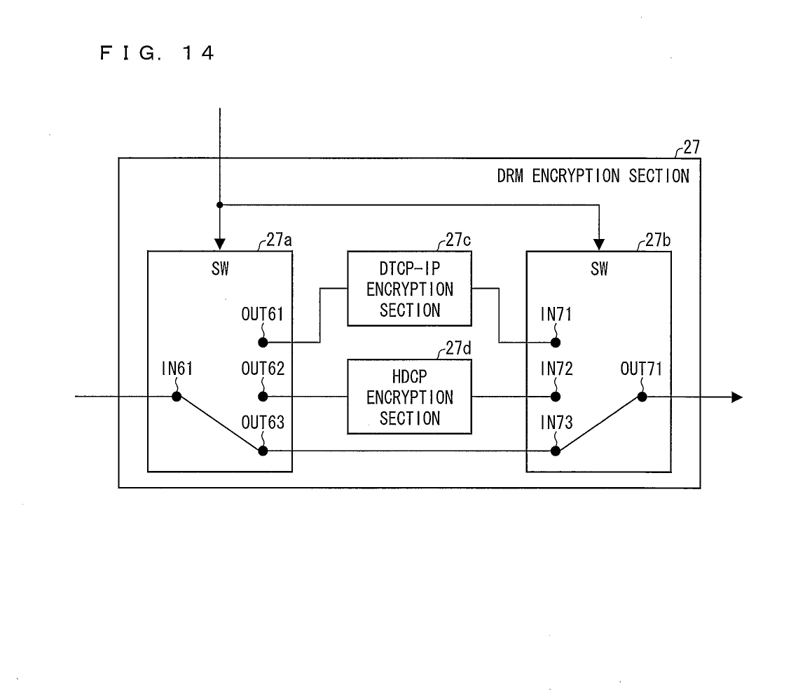

The video signal outputted from the SW 26 is DRM-encrypted by the DRM encryption section 27 in a manner that suits the content source. As shown in FIG. 14, the DRM encryption section 27 includes two SWs 27a and 27b, a DTCP-IP encryption section 27c, and an HDCP encryption section 27d.

The SW 27a includes one input terminal IN61 and three output terminals OUT61 through OUT63. The SW27b includes three input terminals IN71 through IN73 and one output terminal OUT71. Switching from the SW 27a to the SW 27b, or vice versa, is controlled by the CPU 21.

The DTCP-IP encryption section 27c encrypts a video signal according to the DTCP-IP format. The DTCP-IP encryption section 27c is provided between the output terminal OUT61 of the SW 27a and the input terminal IN71 of the SW 27b. The HDCP encryption section 27d encrypts a video signal according to the HDCP format. The HDCP encryption section 27d is provided between the output terminal OUT62 of the SW 27a and the input terminal IN72 of the SW 27b. The output terminal OUT63 of the SW 27a and the input terminal IN73 of the SW27b are directly connected to each other.

By controlling the SWs 27a and 27b, the CPU 21 encrypts a video signal according to an encryption format for the selected content source. For example, in a case where the selected content source is the DTV/BS antenna 50, the CPU 21 controls the DRM encryption section 27 so that the DTCP-IP encryption section 27c is selected. Namely, the CPU 21 controls the SW 27a to select the output terminal OUT61, and controls the SW 27b to select the input terminal IN71. Similarly, in a case where the selected content source is the BD recorder 40a, the CPU 21 controls the DRM encryption section 27 so that the HDCP encryption section 27d is selected.

In a case where the selected content source is the router 30, the DRM encryption section 27 does not encrypt a video signal received by the wired LAN module 25, since the video signal has been already encrypted. In this case, the CPU 21 controls the SW 27a to select the output terminal OUT63, and controls the SW 27b to select the input terminal IN73.

As a result, the video signal encrypted appropriately according to the selected content source is transmitted from the wireless LAN module 28 to the monitor 10.

Note that, in terms of interconnection, it is advantageous that a video signal already coded by MPEG2 or H.264 such as a video signal from the media server 60 (as shown in FIG. 7) is not encrypted according to HDCP but according to another format such as DTCP-IP, since DLNA is a widely-known communication mode.

Since the router 30 shown in FIG. 1 does not carry out decoding or encryption, the router 30 does not include a decoding section or an encryption section.

(Display Mode of Icons)

Here, assume that a certain content source is not available. For example, assumed is (i) a case where the STB 20 is physically disconnected from a content source such as a case where an HDMI cable of the BD recorder 40a, which is connected to the STB 20, is disconnected or a case where an antenna cable of the DTV/BS antenna 50 is disconnected or (ii) a case where the access point itself is unavailable such as a case where a power source cable of the STB 20 is disconnected.

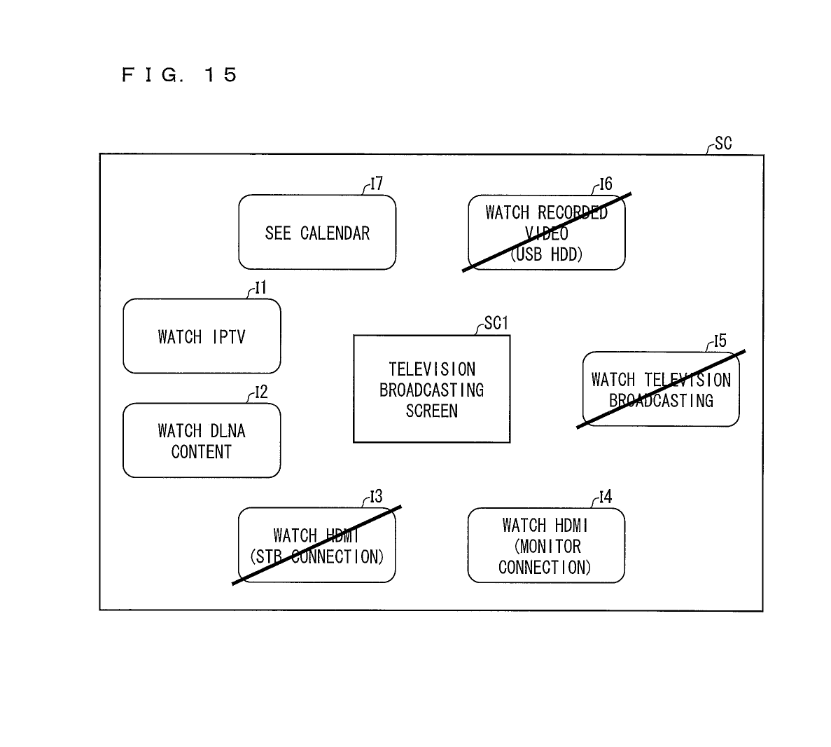

FIG. 15 shows an example of a display on the content selection screen observed when the monitor 10 is connected to the router 30 and the STB 20 is unavailable. Since the STB 20 is unavailable, a content managed by the STB 20 cannot be watched through the monitor 10. Thus, as shown in FIG. 15, an oblique line is indicated on each of the icons 13, 15, and 16 of content sources, whose videos cannot be displayed, so that the icons 13, 15, and 16 are made unselectable.

Thus, the content selection screen displays unavailable content sources in such a manner as to be identified as unavailable, thereby preventing a user from selecting an unavailable content source. Consequently, operability is improved.

Further, the content selection screen may indicate a connection relationship between the contents and the APs (i.e., to which of the APs a respective content is connected) for a different purpose. For example, in a case where IPTV or the like is selected in a state where the monitor 10 is connected to the STB 20, a connection destination of the monitor 10 is automatically switched from the STB 20 to the router 30, so that IPTV or the like can be watched. However, it takes some time to switch from one AP to another AP. Therefore, if the connection relationship between the contents and the APs is not indicated, the following cases may occur: switching to one content is smooth, but switching to another content takes time unexpectedly. This provides poor operability.

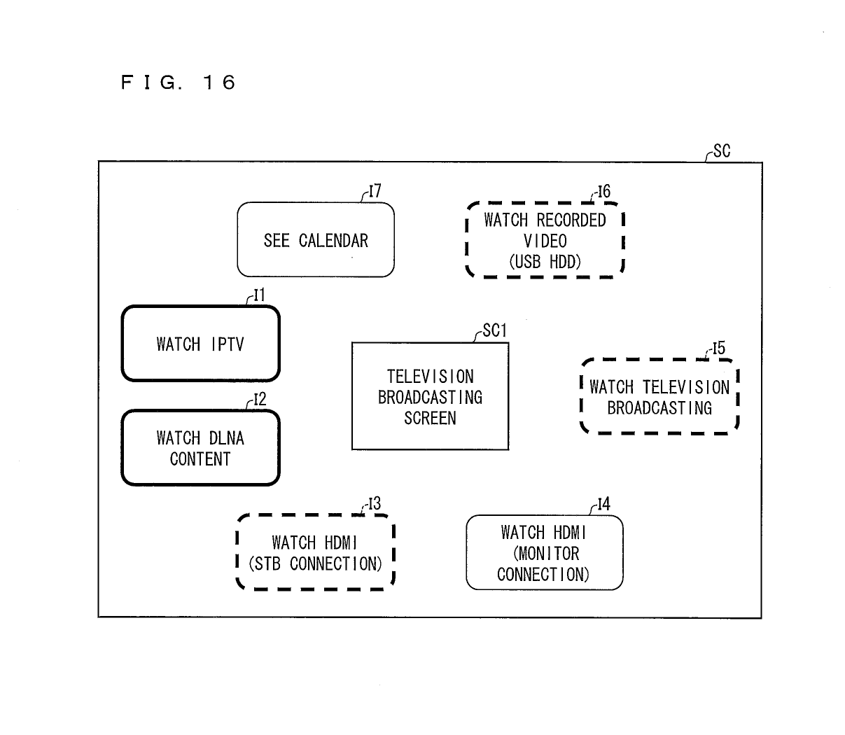

In order to deal with this, an oblique line and/or a broken line are/is used to display a content which requires switching from one of the APs to another. This allows the user to clearly distinguish between (i) a content which requires switching from one of the APs to another and (ii) a content which does not require switching from one of the APs to another. This prevents the user from unnecessarily carrying out an operation of switching from one of the APs to another, thereby improving operability. For example, in FIG. 16, the icons 13 and 16, each of which is of a content requiring switching from one of the APs to another, are displayed by broken lines.

(System Variation 1)

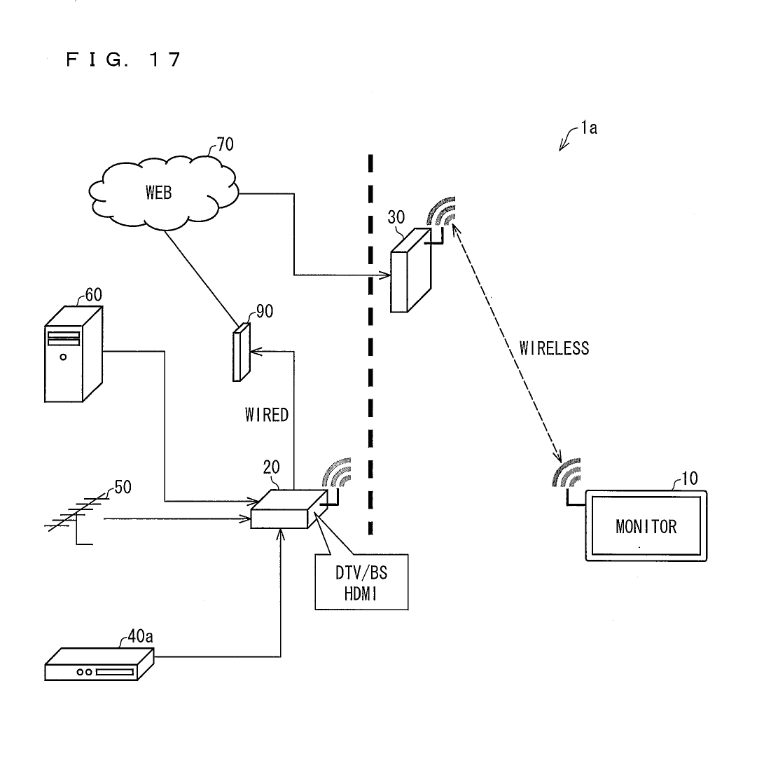

Next, with reference to FIGS. 17 through 23, the following describes variations of the content receiving system according to the present embodiment.

FIG. 17 shows an overall configuration of a content receiving system la according to a variation of the present embodiment. The content receiving system la includes a monitor 10, an STB 20, and routers 30 and 90. The content receiving system la receives a video content from any of three content sources, i.e., a BD recorder 40a, a DTV/BS antenna 50, and a media server 60.

The monitor 10 and the router 30 are located in the outside (e.g., an external place where a user has gone to) of a building in which the STB 20 is provided. The monitor 10 and the router 30 are wirelessly connected to each other.

The STB 20 and the router 30 are connected to each other via the router 90 and the web 70. The STB 20 is connected to the BD recorder 40a, the DTV/BS antenna 50, and the media server 60.

This configuration allows the monitor 10 to receive, via the router 30, a content such as IPTV or VOD (video on demand) supplied from the web 70, and also allows the monitor 10 to receive, via the STB 20, the router 90, the web 70, and the router 30, a content supplied to the STB 20 from any of the BD recorder 40a, the DTV/BS antenna 50, and the media server 60. Thus, the user can watch the content supplied from any of the DTV/BS antenna 50, the media server 60, and the web 70 even in an external place where the user has gone.

(System Variation 2)

The above-described embodiment has described the configuration in which the STB 20 is set to be wirelessly connectable only to the monitor 10. This setting is to omit an initial setting which is carried out by the user who uses a product for wireless connection for the first time so that a monitor and an STB in the product recognize each other for registration, for the purpose of eliminating an unnecessary burden on the user who is inexperienced in wireless settings.

Described here is a configuration in which the STB 20 can register a plurality of entities with which the STB 20 carries out wireless communication.

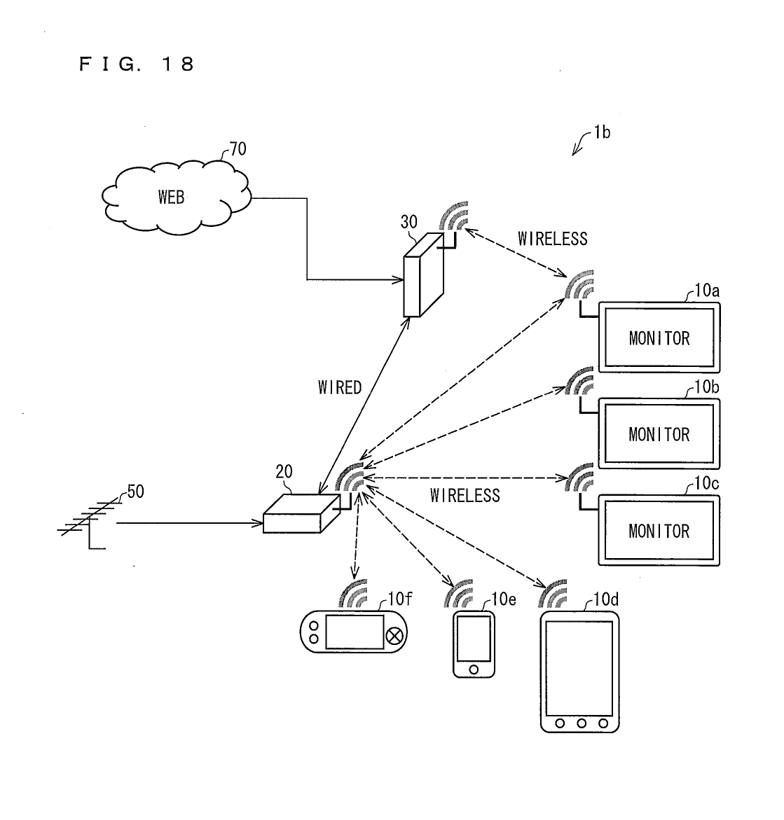

FIG. 18 shows an overall configuration of a content receiving system lb according to another variation of the present embodiment. The content receiving system lb includes six monitors 10a through 10f, an STB 20, and a router 30. The content receiving system lb receives a video content from any of the DTV/BS antenna 50 and the web 70.

Each of the monitors 10a through 10f is wirelessly connected to the STB 20 and the router 30. The STB 20 and the router 30 may be wire-connected to each other or may be wirelessly connected to each other. Each of the monitors 10a through 1 Of has substantially the same configuration as that of the monitor 10 shown in FIG. 8. Thus, a user of each of the monitors 10a through 10f can select a content server without manually switching from one access point to another access point.

In this configuration, the STB 20 transmits data in response to a request from each of the monitors 10a through 10f. However, it is assumed that a plurality of monitors request the STB 20 to transmit the same data almost at the same time. An example of this is a case where a certain television program is watched through the plurality of monitors. In such the case, the STB 20 can transmit data by multicasting. The “multicasting” means simultaneously transmitting data to a certain plurality of terminals in a network. By carrying out one-to-many communications, it is possible to reduce a load on the network.

Consequently, regardless of the number of monitors connected to the STB 20, the users can comfortably watch a content with their respective monitors.

(System Variation 3)

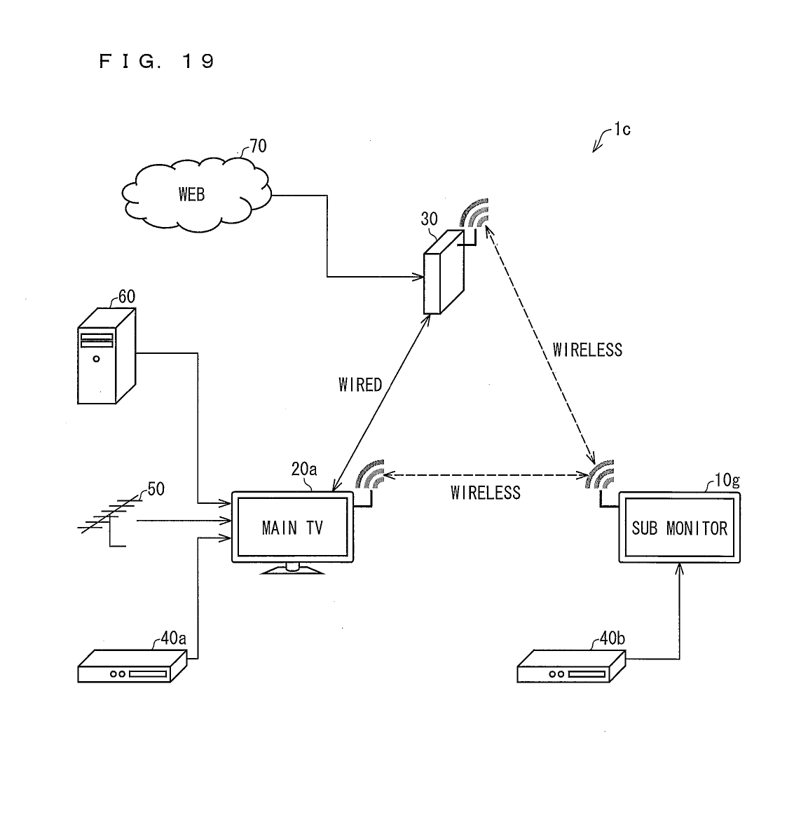

FIG. 19 shows an overall configuration of a content receiving system 1c according to further another variation of the present embodiment. The content receiving system 1c includes a sub monitor 10g, a main TV 20a, and a router 30. The content receiving system 1c receives a video content supplied from any of BD recorders 40a and 40b, a DTV/BS antenna 50, a media server 60, and a web 70.

The sub monitor 10g is, for example, a mobile phone, and is wirelessly connected to the main TV 20a and the router 30. The main TV 20a corresponds to the STB 20 in the content receiving system 1 shown in FIG. 1, the STB 20 being configured to additionally have a video display function. Thus, the main TV 20a functions as an ordinary display apparatus and also as an access point. The main TV 20a and the router 30 are wire-connected to each other. Namely, the content receiving system 1c corresponds to the content receiving system 1 shown in FIG. 1 configured such that the monitor 10 and the STB 20 are replaced with the sub monitor 10g and the main TV 20a, respectively.

The sub monitor 10g has a similar function to that of the monitor 10 shown in FIG. 8. With this, a video content from any of the content sources can be watched through the main TV 20a in the interior of a building. Not only this, a video content from any of the content sources can be watched also through the sub monitor 10g even in the outside of the building.

(System Variation 4)

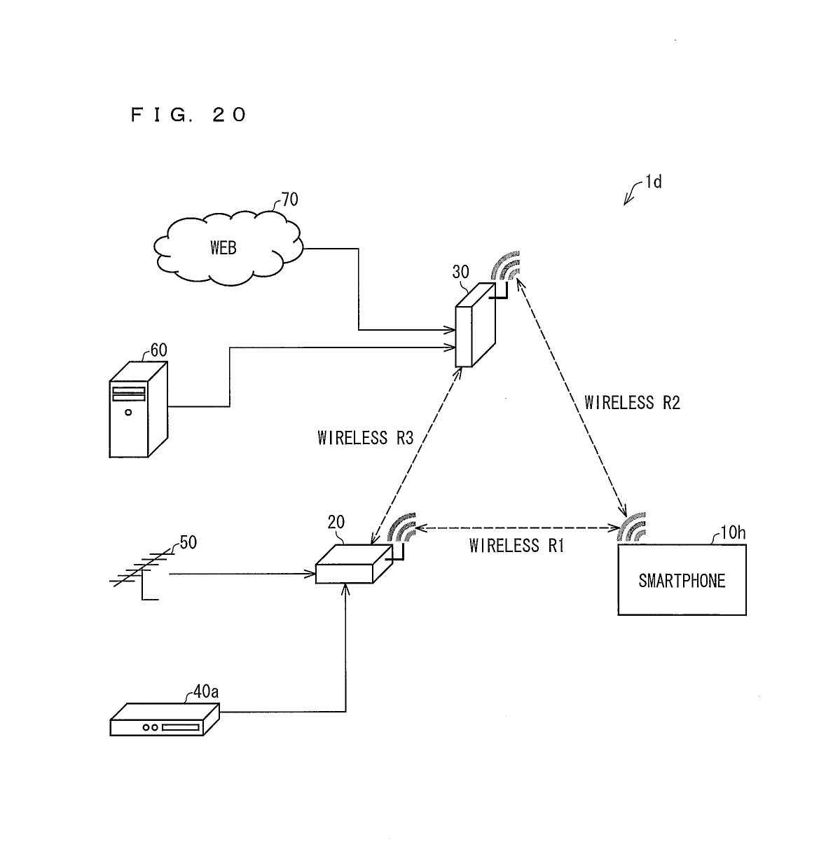

FIG. 20 shows an overall configuration of a content receiving system ld according to still further another variation of the present embodiment. The content receiving system 1d includes a smartphone 10h, an STB 20, and a router 30. The content receiving system 1 d receives a video content supplied from any of a BD recorder 40a, a DTV/BS antenna 50, a media server 60, and a web 70.

The smartphone 10h is connected to the STB 20 by wireless R1, and is connected to the router 30 by wireless R2. The STB 20 and the router 30 are connected to each other by wireless R3.

It is desirable that the smartphone 10h switch from one connection route to another connection route automatically by itself according to the content source to which the smartphone 10h is to be connected. For example, it is desirable that the smartphone 10h make connection to the router 30 if the video content is a VOD from the web 70, and that the smartphone 10h make connection to the STB 20 if the video content is a DTV from the DTV/BS antenna 50.

However, in a case where the smartphone 10h cannot switch from one connection route to another connection route automatically, there exist four connection routes for the smartphone 10h to receive a content source. A first one of the four connection routes is a route in which the smartphone 10h is directly connected to a content source managed by the STB 20 via the wireless R1. A second one of the four connection routes is a route in which the smartphone 10h is indirectly connected to a content source managed by the STB 20 via the wireless R3, the router 30, and the wireless R2. A third one of the four connection routes is a route in which the smartphone 10h is directly connected to a content source managed by the router 30 via the wireless R2. A fourth one of the four connection routes is a route in which the smartphone 10h is indirectly connected to a content source managed by the router 30 via the wireless R3, the STB 20, and the wireless R1.

For example, assume a case where the smartphone 10h is to receive DTV broadcasting from the DTV/BS antenna 50. In such the case, if the DTV broadcasting to be received is BS digital broadcasting, a content is transmitted at a rate of 24 Mbps, and thus a physical layer of 30 Mbps or more is required. Thus, the indirect connection via the wireless R3, the router 30, and the wireless R2 consumes a wireless communication section of 60 Mbps or more. This is inefficient and increases a possibility of causing a communication error.

In order to deal with this, when a terminal (the smartphone 10h) is connected to the STB 20, the STB 20 judges whether the connection is the indirect connection via the router 30 or the direct connection (wireless R1). If the connection is determined to be the indirect connection via the router 30, the STB 20 transmits, to the smartphone 10h, a message of recommending a user to select the direct connection.

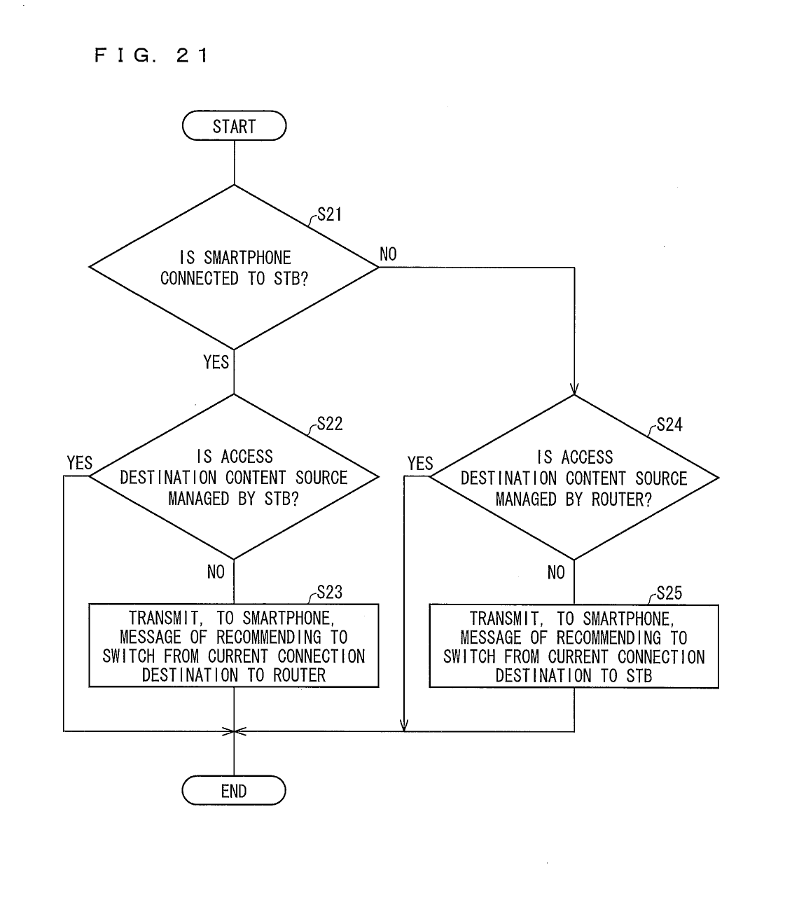

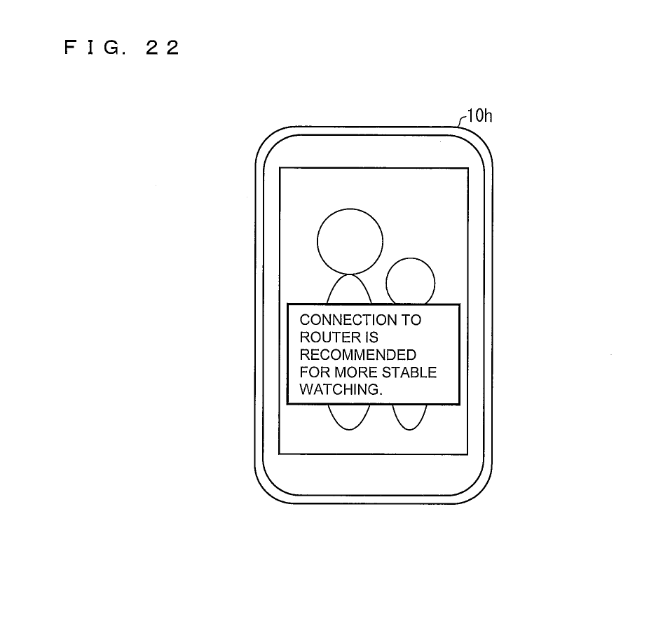

FIG. 21 is a flow chart of procedures for setting a transmission route from a content source to the smartphone 10h. In a case where the smartphone 10h is connected to the STB 20 (“YES” in S21), the STB 20 judges whether or not an access destination (a content source to be received) of the smartphone 10h is a content source managed by the STB 20 (S22). If the access destination of the smartphone 10h is not the content source managed by the STB 20, i.e., if the access destination is a content source managed by the router 30 (“NO” in S22), the STB 20 transmits, to the smartphone 10h, a message of recommending the user to switch from the current connection destination to the router 30 (S23). Consequently, a message as that shown in FIG. 22 is indicated on the smartphone 10h.

Further, in a case where the smartphone 10h is not connected to the STB 20 (i.e., the smartphone 10h is connected to the router 30) (“NO” in S21), the STB 20 judges whether or not the access destination of the smartphone 10h is a content source managed by the router 30 (S24). If the access destination of the smartphone 10h is determined not to be the content source managed by the router 30, i.e., if the access destination is the content source managed by the STB 20 (“NO” in S24), the STB 20 transmits, to the smartphone 10h via the router 30, a message of recommending the user to switch from the current connection destination to the STB 20 (S25). Consequently, the message as above is displayed on the smartphone 10h.

Provided that the STB 20 is capable of switching from one connection destination of the smartphone 10h to another with use of a command, the STB 20 may transmit a switching command to the smartphone 10h as below.

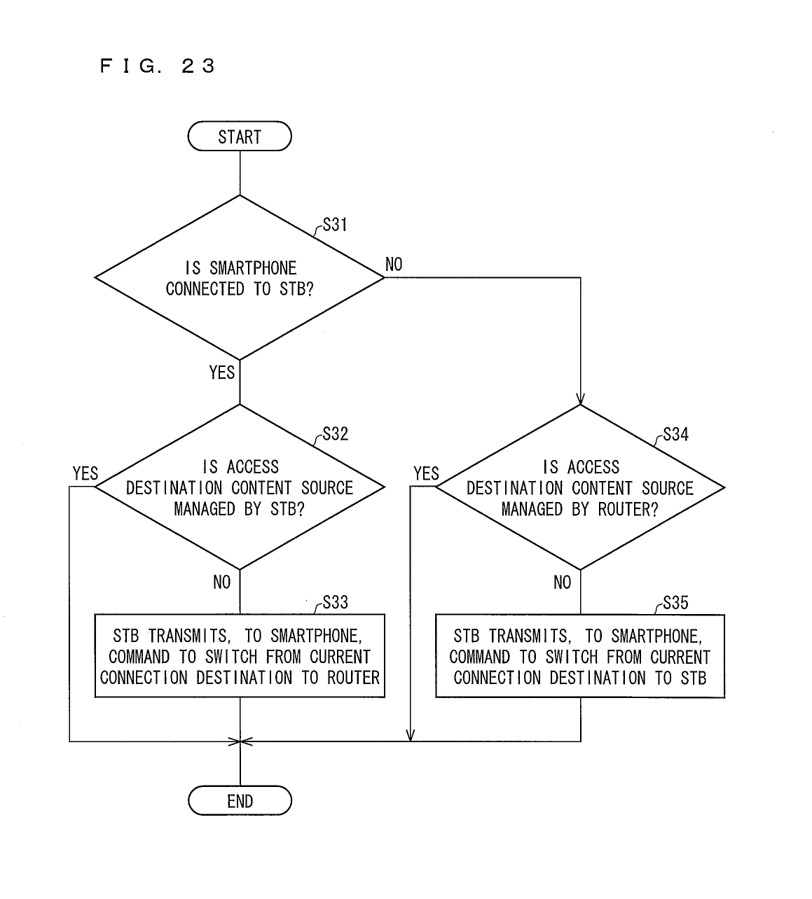

FIG. 23 is a flow chart of a variation of procedures for setting a transmission route from a content source to the smartphone 10h. If the smartphone 10h is connected to the STB 20 (“YES” in S31), the STB 20 judges whether or not the access destination of the smartphone 10h is a content source managed by the STB 20 (S32). If the access destination of the smartphone 10h is not the content source managed by the STB 20, i.e., if the destination is a content source managed by the router 30 (“NO” in S32), the STB 20 transmits, to the smartphone 10h, a command to switch from the current connection destination to the router 30 (S33). Consequently, the connection destination of the smartphone 10h is automatically switched from the current one to the router 30.

Further, if the smartphone 10h is not connected to the STB 20 (i.e., the smartphone 10h is connected to the router 30) (“NO” in S31), the router 30 judges whether or not the access destination of the smartphone 10h is a content source managed by the router 30 (S34). If the access destination of the smartphone 10h is not the content source managed by the router 30, i.e., if the destination is a content source managed by the STB 20 (“NO” in S34), the STB 20 transmits, to the smartphone 10h via the router 30, a command to switch from the current connection destination to the STB 20 (S35). Consequently, the connection destination of the smartphone 10h is automatically switched from the current one to the STB 20.

As described above, even in a case where the smartphone 10h cannot switch from one connection route to another connection route automatically, it is possible to set a suitable transmission route from a content source to the smartphone 10h.

(Implementation of the Present Invention by way of Software)

Each of the monitor 10 and the STB 20 of the present embodiment may be configured by way of a hardware logic. Alternatively, at least a part of functions of each of the monitor 10 and the STB 20 may be configured by way of software as executed by a CPU as follows:

The monitor 10 and the STB 20 each include a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a storage medium such as a memory containing the programs and various data. The object of the present invention can also be achieved by mounting to the monitor 10 and the STB 20 a computer-readable storage medium containing control program code (executable program, intermediate code program, or source program) for the monitor 10 and the STB 20, which is software realizing the aforementioned functions, in order for the computer (or CPU, MPU) to retrieve and execute the program code contained in the storage medium.

The storage medium may be, for example, a tape such as a magnetic tape or a cassette tape; a magnetic disk such as a floppy (Registered Trademark) disk or a hard disk, or an optical disk such as CD-ROM/MO/MD/DVD/CD-R; a card such as an IC card (memory card) or an optical card; or a semiconductor memory such as a mask ROM/EPROM/EEPROM/flash ROM.

The monitor 10 and the STB 20 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line such as IEEE 1394, USB, electric power line, cable TV line, telephone line, or ADSL line; or wireless such as infrared radiation (IrDA, remote control), Bluetooth (Registered Trademark), 802.11 wireless, HDR, mobile telephone network, satellite line, or terrestrial digital network. The present invention encompasses a computer data signal in which the program code is embodied electronically and which is embedded in a carrier wave.

(Additional Descriptions)

The above-described embodiment includes two access points, the STB and the router. However, the number of access points is not limited to this, and may be three or more. Further, the number of content sources connected to each access point is not limited to those disclosed in the above-described embodiments.

The present invention is not limited to the description of the embodiments above, but may be altered by a skilled person within the scope of the claims. An embodiment based on a proper combination of technical means disclosed in different embodiments is encompassed in the technical scope of the present invention.

The video reproducing apparatus according to the embodiment of the present invention preferably includes a plurality of decoding means each decoding a video signal which is encrypted; and decoding selection means for selecting, according to an encryption format of the video signal received by the receiving means, decoding means for the encryption format from among the plurality of decoding means.

According to the above configuration, the decoding selection means selects, according to the encryption format of the video signal received by the receiving means, decoding means for the encryption format from among the plurality of decoding means, and therefore can decode the received video signal appropriately.

A video transmitting apparatus according to the embodiment of the present invention is a video transmitting apparatus for wirelessly transmitting a video signal to the above video reproducing apparatus, including: a plurality of video input means each for receiving a video signal from a respective one of a plurality of content sources, each of which serves as a destination to which a video signal to be transmitted to the video reproducing apparatus is supplied; video input control means for selecting, from among the plurality of video input means, video input means for receiving the video signal from the selected one of the content sources, according to an instruction from the instructing means in the video reproducing apparatus; a plurality of content protection means each for encrypting a video signal; and content protection selecting means for selecting, from among the plurality of content protection means, content protection means for the selected one of the content sources.

According to the above configuration, the video input control means selects, from among the plurality of video input means, the video input means receiving the video signal from the video signal, according to the instruction from the instructing means in the video reproducing apparatus. Consequently, only the selected video input means carries out an operation of receiving the video signal. Further, the content protection selecting means selects, from among the plurality of content protection means, the content protection means for the content source according to the selected content source. This makes it possible to encrypt the received video signal appropriately.

A video reproducing program according to the embodiment of the present invention is a video reproducing program for causing a computer to operate as the above video reproducing apparatus, said video reproducing program causing the computer to function as each means of the video reproducing apparatus.

A video transmitting program according to the embodiment of the present invention is a video transmitting program for causing a computer to operate as the above video transmitting apparatus, said video transmitting program causing the computer to function as each means of the video transmitting apparatus.

The above video reproducing program and video transmitting program are respectively stored in computer-readable storage media.

It should be noted that the present invention can also be expressed as follows:

A video reproducing apparatus according to the embodiment of the present invention is a video reproducing apparatus for wirelessly receiving a video signal and reproducing the video signal, including: video reception switching control means for switching from one of two or more video source apparatuses to another so as to select a video source apparatus from which a video content is received; access point switching means capable of switching from one of two or more access points to another so as to select an access point to which the video reproducing apparatus is connected; two or more encryption decoding means; and decoding switching means for switching from one of the two or more decoding means to another, the video reproducing apparatus (i) switching from one of the two or more access points to another so as to select an access point to which the video reproducing apparatus is connected and (ii) switching from one of the two or more decoding means to another, in response to switching from one of video content sources to another.

Further, the video reproducing apparatus according to the embodiment of the present invention preferably includes different video decoding means.

Furthermore, the video reproducing apparatus according to the embodiment of the present invention is a video reproducing apparatus for wirelessly receiving a video signal and reproducing the video signal, the video reproducing apparatus being capable of switching from one type of access point to another type of access point, and being capable of changing a reproducible content source according to the type of access point.

Further, the video transmitting apparatus according to the embodiment of the present invention is a video transmitting apparatus for wirelessly transmitting a video signal, the video transmitting apparatus including: two or more video source input means, two or more content protection means, video transmitter means for transmitting a video to an external apparatus, and control means for carrying out control according to an instruction from the external apparatus, the video transmitting apparatus switching, according to the instruction from the external apparatus, from one video input source to another video input source and changing a content protection means which is used to transmit the video signal.

### INDUSTRIAL APPLICABILITY

The present invention is applicable to a receiving system for receiving a video signal from any of a plurality of content sources.

### REFERENCE SIGNS LIST

1 Content receiving system

1a Content receiving system

1b Content receiving system

1c Content receiving system

1d Content receiving system

10 Monitor (video reproducing apparatus)

10a through 10f Monitors (video reproducing apparatuses)

10g Sub monitor (video reproducing apparatus)

10h Smartphone (video reproducing apparatus)

11 CPU

11a Selection screen display section (selection screen display means)

11b Content selecting section (content selecting means)

11c Video reception selecting section (video reception selecting means)

11d Content switching instructing section (instructing means)

12a Wireless LAN module (receiving means)

12b HDMI receiving section (receiving means)

13 Switch (decoding selection means)

14 DRM decoding section (decoding means)

14c DTCP-IP decoding section (decoding means)

14d HDCP decoding section (decoding means)

14e Marlin decoding section (decoding means)

15 DEMUX

16 Video decoding section

16c MPEG2 decoding section

16d H.264 decoding section

17 Look-up table

18a Video processing section

18b Panel controller

19 Display

20 Set-top box (video transmitting apparatus)

20a Main TV (video transmitting apparatus, video reproducing apparatus)

21 CPU (video input control means)

22a Tuner (video input means)

22b Modulating section

22c Multi2 decoding section

22d DEMUX

23a USB interface (video input means)

23b Unique DRM decoding section

24a HDMI receiving section (video input means)

24b HDCP decoding section

24c H.264 coding section

25 Wired LAN module (video input means)

26 Switch (content protection selecting means)

27 DRM encryption section

27c DTCP-IP encryption section (content protection means)

27d HDCP encryption section (content protection means)

28 Wireless LAN module

30 Router (video transmitting apparatus)

40a BD recorder (content source)

40b BD recorder (content source)

50 DTV/BS antenna (content source)

60 Media server (content source)

70 Web (content source)

80 USB-HDD (content source)

90 Router

I1 through I7 Icons

R1 Wireless

R2 Wireless

R3 Wireless

SC Content selection screen

SC1 Television broadcasting screen

1-8. (canceled)

9. A video reproducing apparatus, comprising:
receiving means for wirelessly receiving a video signal from any of a plurality of video transmitting apparatuses, each of the plurality of video transmitting apparatuses being connected to at least one of content sources, each of which serves as a source for supplying a video signal to be transmitted to the video reproducing apparatus;
selection screen display means for displaying a content selection screen indicating content sources which are reproducible;
content selecting means for selecting one of the content sources in response to a user's operation carried out on the content selection screen;
video reception selecting means for (i) identifying, from among the plurality of video transmitting apparatuses, a video transmitting apparatus connected to the selected one of the content sources and (ii) causing the receiving means to receive a video signal from the identified video transmitting apparatus; and
instructing means for instructing the identified video transmitting apparatus to transmit a video signal from the selected one of the content sources,
the selection screen display means displaying the content sources in such a manner that (i) a content source connected to, from among the plurality of video transmitting apparatuses, a video transmitting apparatus from which the receiving means receives a video signal and (ii) a content source connected to, from among the plurality of video transmitting apparatuses, a video transmitting apparatus from which the receiving means does not receive a video signal are distinguished from each other.

10. A video transmitting apparatus for wirelessly transmitting a video signal to a video reproducing apparatus as set forth in claim 9, comprising:
a plurality of video input means each for receiving a video signal from a respective one of a plurality of content sources, each of which serves as a source for supplying a video signal to be transmitted to the video reproducing apparatus;
video input control means for selecting, from among the plurality of video input means, video input means for receiving the video signal from the selected one of the content sources, according to an instruction from the instructing means in the video reproducing apparatus;
a plurality of content protection means each for encrypting a video signal; and
content protection selecting means for selecting, from among the plurality of content protection means, content protection means for the selected one of the content sources.

11. A non-transitory computer-readable storage medium in which a video reproducing program as set forth in claim 9 is stored and which causes a computer to function as each means of the video reproducing apparatus.

12. A non-transitory computer-readable storage medium in which a video transmitting program as set forth in claim 10 is stored and which causes a computer to function as each means of the video transmitting apparatus.
